(19) United States
(12) Patent Application Publication
(10) Pub. No.: US 2012/0113091 A1
(43) Pub. Date: May 10, 2012

(54) Remote Graphics

(76) Inventor: Joel Solomon Isaacson, Rehovot (IL)

(21) Appl. No.: 13/281,460

(22) Filed: Oct. 26, 2011

Related U.S. Application Data
(60) Provisional application No. 61/407,923, filed on Oct. 29, 2010.

(51) Int. Cl. G06T 1/00

(52) U.S. Cl. 345/418

(57) ABSTRACT

A system that allows graphics to be displayed on a local device via a communication channel connected to a remote computing device.

### CROSS REFERENCE TO OTHER APPLICATIONS

This application claims priority to U.S. Provisional Patent Application No. 61/407,923 entitled REMOTE ANDROID filed Oct. 29 2010 which is incorporated herein by reference for all purposes.

### FIELD OF THE INVENTION

This invention generally relates to computerized rendering of graphics and more specifically to a system and method of enabling of remote graphics in systems that have not been specifically designed to enable remote transmission of graphics.

### BACKGROUND

Remote graphics systems have a long history and are widely used. One of the earliest, called the X window system, usually abbreviated X11, was introduced in 1984 and is in common use today. Unlike most earlier display protocols, X11 was designed to separate the graphic stack into two processes that communicate only via IPC (Inter Process Communications). The X11 protocol is designed to be used over a network between different operating systems, machine architectures and a wide array of graphic display hardware. X11's network protocol is based on the original 2-D X11 command primitives and the more recently added OpenGL 3D primitives for high performance 3-D graphics. This allows both 2-D and 3-D operations to be fully accelerated on the X11 display hardware.

The upper layers of the graphic stack is the X11 client. The lower layers of the graphic stack is called the X11 server. The X11 client-server can run physically on one machine or can be split between two separate machines that are in different locations. It is important to note that the client-server relationship in X11 is notationally inverted in relationship to most systems such as Microsoft's Remote Desktop Protocol (RDP).

The X11 client normally consists of a user application constructed from the API of a GUI widget toolkit. The Graphical User Interface (GUI) widget toolkit is constructed from the X11 protocol library called Xlib. Xlib is the X11 client side remote rendering library. The X11 client can therefore be thought of as a tri-layered software stack: App-Toolkit-Xlib.

The X11 server runs on the machine with the actual graphic display hardware. It consists of a higher level hardware independent part which deals with the X11 protocol rendering stream. The lower level of the server deals with the actual displaying of the rendered data on the graphics display.

The X11 protocol was designed for low latency, high speed, local area networks. When used with a high latency, low speed data link, such as a long haul internet link, its performance is very poor. There are a number a solutions to these problems. One notable solution is from NX technology which accelerates the use of the X11 protocol over high latency and low speed data links. It tackles the high latency by eliminating most round trip exchanges between the server and client. It also aggressively caches bitmapped data on the server end and addresses the problem of low speed by using data compression to minimize the amount of transmitted data.

Another widely used remote graphics protocol is the Remote Desktop Protocol (RDP) a proprietary protocol developed by Microsoft, which provides a user with a graphical interface to another computer. This system provides remote access to more than just graphics. Clients exist for most versions of Microsoft Windows (including WINDOWS® Mobile), Linux, Unix, Mac OS X, ANDROID™, and other modern operating systems.

There are many other examples of proprietary client-server remote desktop software products such as Oracle/Sun Microsystems' Appliance Link Protocol, Citrix's Independent Computing Architecture and Hewlett-Packard's Remote Graphics Software.

All the above remote graphics systems have been carefully designed to allow remote access to graphic applications. There are some systems that can be used to retrofit remote capabilities in systems that have not been specifically designed for remote graphics such as Virtual Network Computing (VNC).

VNC is a graphical desktop sharing system that uses the Remote FrameBuffer (RFB) protocol to remotely control another computer. It sends graphical screen updates, over a network from the VNC server to the VNC client.

The VNC protocol is pixel based. This accounts both for its greatest strengths and for its weaknesses. Since it is pixel based, the interaction with the graphics server can be via a simple mapping to the display framebuffer. This allows simple support for many different systems without the need to provide specific support for the sometimes complex higher level graphical desktop software. VNC server/clients exist for most systems that support graphical operations. On the other hand, VNC is often less efficient than solutions that use more compact graphical representations such as X11 or WINDOWS® Remote Desktop Protocol. Those protocols send high level graphical rendering primitives (e.g., “draw circle”), whereas VNC just sends the raw pixel data.

Recent developments in graphical acceleration hardware and the acceptance of a richer user experience have led to new graphical interface systems that abandoned the possibility of network transparency. This is true for Apple's IOS and Google's ANDROID™ graphics subsystems. Recent announcements would seem to indicate that the next generation of the Unix-Linux graphic stack is migrating from the network-friendly X11 to the non-networked enabled Wayland display server protocol. These new graphic systems allow the re-rendering of full screen graphics at a very high frame rate. Traditionally, X11 programs minimized rendering by doing only partial redraws of graphics for each frame.

There is a general push to cloud computing which centralizes the computational elements and provides services over a network (typically the Internet). Remote graphics is typically done with HTML5. It is unclear whether this model will enable a sufficiently rich graphical interface as users have grown to expect.

### SUMMARY OF THE INVENTION

The standard graphics stack of computerized devices normally is visualized as a multilevel stack. Each computational element on the stack exchanges data with the elements directly above and below them. Many graphic stacks are designed with the assumption that all the elements of the stack reside on one device. It is sometimes advantageous to distribute the graphics stack between more than one device. There are multiple ways to distribute the elements between different devices.

In order to distribute the graphic rendering, network communications has to be established between elements of the stack residing on different machines. This invention deals with retrofitting graphic stacks that were not designed for remote operation to work efficiently with the graphic stack split between machines.

### BRIEF DESCRIPTION OF THE DRAWINGS

FIG. 1 is a simplified diagram of a system for remote graphics with a distributed graphics stack, in accordance with an embodiment of the present invention.

FIG. 2 is a view of a cellphone, running ANDROID™ an operating system for mobile devices, displaying a list of contacts

FIG. 3 is a view of one contact taken from FIG. 2.

FIG. 4 is the graphic stack of ANDROID™, an operating system for mobile devices that is in the prior art.

FIG. 5 is a simplified diagram of a system for remote graphics with a distributed graphics stack, in accordance with an alternate embodiment of the present invention.

FIG. 6 is a simplified diagram of an ANDROID™ system for remote graphics with a distributed graphics stack, in accordance with an embodiment of the present invention.

FIG. 7 is a typical graphic stack for a digital device that is in the prior art.

FIG. 8 is a depiction of the three main data structures of the renderer trace parser, in accordance with an embodiment of the present invention.

FIG. 9 is a depiction of the construction of a control sequence (function) from control_seq structures, in accordance with an embodiment of the present invention.

FIG. 10 is a depiction of the construction of a data sequence from data_seq structures, in accordance with an embodiment of the present invention.

FIG. 11 is a depiction of the structure of the function table array, in accordance with an embodiment of the present invention.

### BRIEF DESCRIPTION OF THE TABLES

TABLE 1 shows the three line difference between LISTING 2 and LISTING 5, in accordance with an embodiment of the present invention.

TABLE 2 shows the one line difference between LISTING 2 and LISTING 6, in accordance with an embodiment of the present invention.

TABLE 3 shows a tabular template that is used to categorize and/or enumerate system configurations systematically. There are eight entries in this table, in accordance with an embodiment of the present invention.

TABLE 4 describes the configuration of an ARM/Intel based server that functions as a remote ANDROID™ application engine serving a local ANDROID™ device, in accordance with an embodiment of the present invention.

TABLE 5 describes the configuration of an ARM/Intel Non-ANDROID™ based server that functions as a remote application engine serving a local ANDROID™ device, in accordance with an embodiment of the present invention.

TABLE 6 describes the configuration of an ARM/Intel ANDROID™ based server that functions as a remote ANDROID™ application engine serving a local Non-ANDROID™ mobile device, in accordance with an embodiment of the present invention.

TABLE 7 describes two co-located ANDROID™ devices, in accordance with an embodiment of the present invention.

TABLE 8 categorizes an ANDROID™ server and a desktop client, in accordance with an embodiment of the present invention.

TABLE 9 shows the correspondence between the two function mappings of LISTING 3 and of LISTING 22, in accordance with an embodiment of the present invention.

TABLE 10 shows the frequency table of the rendering commands. The entropy is calculated in the last line of the table, in accordance with an embodiment of the present invention.

### BRIEF DESCRIPTION OF THE LISTINGS

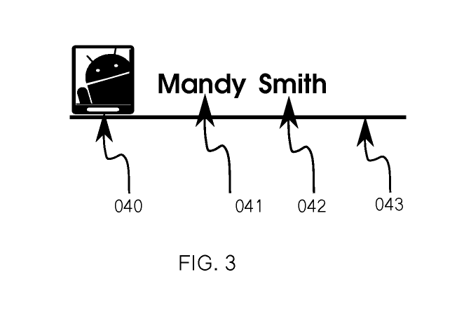

LISTING 1 Shows a trace of the SKIA commands that render FIG. 3, in accordance with an embodiment of the present invention.

LISTING 2 Shows a transformation of LISTING 1. The save/restore commands have been used to structure and indent the listing, in accordance with an embodiment of the present invention.

LISTING 3 Shows a transformation of LISTING 2. The structuring of LISTING 2 was used to convert the listing to functional form, in accordance with an embodiment of the present invention.

LISTING 4 Shows the function contact6( ) that has been generalized, from the version in LISTING 3, by parameterization of all the arguments to SKIA rendering calls, in accordance with an embodiment of the present invention.

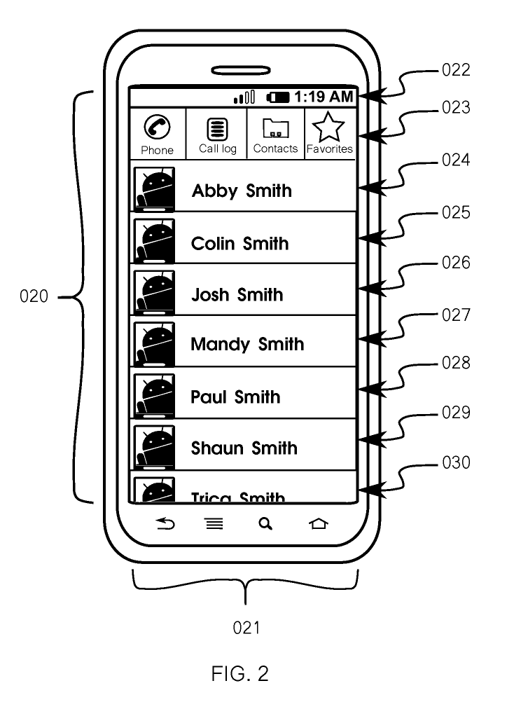

LISTING 5 Shows a trace of the SKIA commands that renders the contact 028 of FIG. 2, in accordance with an embodiment of the present invention.

LISTING 6 Shows a trace of the SKIA commands that renders the contact of FIG. 3, from a frame that has the contact scrolled from the frame of FIG. 2, in accordance with an embodiment of the present invention.

LISTING 7 Shows a listing that contains the data structures definitions, in accordance with an embodiment of the present invention.

LISTING 8 Shows a listing that contains the skeletons for the data transfer routines, in accordance with an embodiment of the present invention.

LISTING 9 Shows a listing that contains the getfunc( ) routine that returns the control function and associated data, in accordance with an embodiment of the present invention.

LISTING 10 Shows a listing that contains the calc_hash( ) function that returns the MD5 checksum of the control sequence, in accordance with an embodiment of the present invention.

LISTING 11 Shows a listing that contains the cmd_lines( ) function that returns the number of lines in the control sequence, in accordance with an embodiment of the present invention.

LISTING 12 Shows a listing that contains the store_func( ) function that enters a control sequence in the function table, in accordance with an embodiment of the present invention.

LISTING 13 Shows a listing that contains the print_cs2( ) function that prints a control sequence, in accordance with an embodiment of the present invention.

LISTING 14 Shows a listing that contains the add_stats( ) and print_stats( ) routine that adds and prints cumulative statistics, in accordance with an embodiment of the present invention.

LISTING 15 Shows a listing that contains the diff_func( ) that find the closest data sequence from a list of previous data sequences, in accordance with an embodiment of the present invention.

LISTING 16 Shows a listing that contains the print_cs( ) routine that recursively prints both the control and data sequences, in accordance with an embodiment of the present invention.

LISTING 17 Shows a listing that contains the get_cs( ) routine which is the main parsing routine, in accordance with an embodiment of the present invention.

LISTING 18 Shows a listing that contains the func_num( ) function. It returns the index of a control sequence in the function table, in accordance with an embodiment of the present invention.

LISTING 19 Shows a listing that contains the print_func_tbl( ) routine, in accordance with an embodiment of the present invention.

LISTING 20 Shows a listing that contains the main( ) routine, in accordance with an embodiment of the present invention.

LISTING 21 Shows the frame by frame cumulative statistics for the 60 frame rendering trace, in accordance with an embodiment of the present invention.

LISTING 22 Shows the output from the program of LISTINGS 7-20 on the concatenation two contact frames shown in LISTINGS 2 and 5, in accordance with an embodiment of the present invention.

### DETAILED DESCRIPTION OF THE INVENTION SYSTEM OVERVIEW

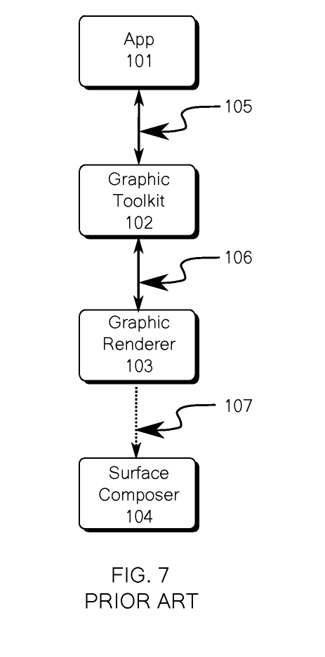

A typical graphics stack is shown in FIG. 7. The user application 101 uses the API of the Graphical Toolkit 102. The Graphical Toolkit 102 uses the API of the Graphical Renderer 103 to render the actual pixels on a buffer. The Surface Composer 104 will compose the graphical image rendered by the Graphical Renderer 103 onto the graphical display. The arrow 105 indicates the interaction between the user application 101 and the Graphical Toolkit 102. The arrow 106 indicated the interaction between the Graphical Toolkit 102 and the Graphical Renderer 103. The arrow 107 indicated the interaction between the Graphical Renderer 103 and the Surface Composer 104. In some embodiments the Surface Composer 104 is absent and the Graphical Renderer 103 renders on the graphical display directly not on an intermediate pixel buffer. In other embodiments the user application 101 and the Graphical Toolkit 102 might be merged into one entity or expanded into more than two entities.

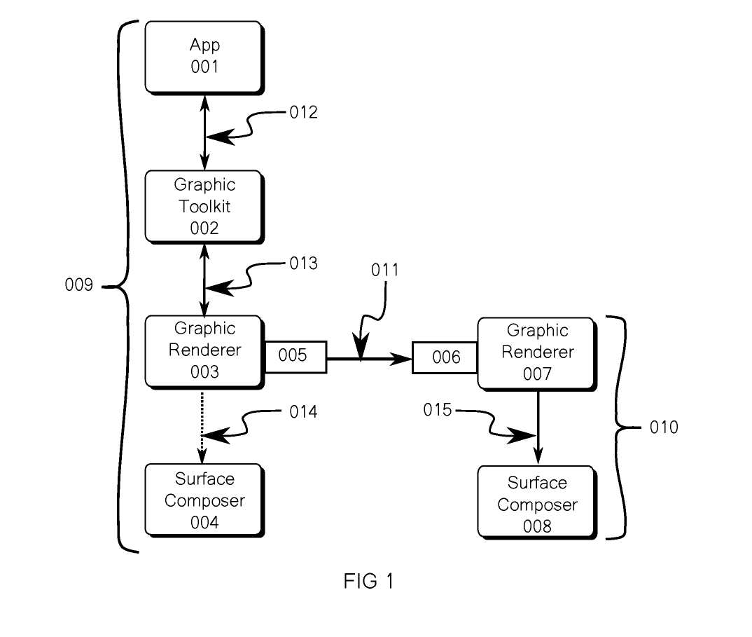

The system software overview is shown in FIG. 1. Here the graphics stack of FIG. 7 has been modified in order to allow rendering to be distributed between two separate devices. The lefthand side of the figure shows the standard graphics stack of a mobile device 009 that will be referred to as the remote device. The right hand side of the figure shows the truncated graphics stack 010 that will be referred to as the local device.

The user application 001 uses the API of the Graphical Toolkit 002. The Graphical Toolkit 002 uses the API of the Graphical Renderer 003. The arrow 012 indicates the interaction between the user application 001 and the Graphical Toolkit 002. The arrow 013 indicates the interaction between the Graphical Toolkit 002 and the Graphical Renderer 003. The arrow 014 indicates the interaction between the Graphical Renderer 003 and the Surface Composer 004. The stack 009 has been modified, from the stack in FIG. 7, to forward requests from the Graphic Renderer 003, via a extension stub 005, which sends graphical rendering requests via a network connection 011, to a extension stub 006, that relays graphical rendering requests to a Graphic Renderer 007 on the local device to render the actual pixels on a buffer. The truncated graphics stack 010 will render 007 and via 015 compose 008 the graphical image on the local device. In some embodiments the Surface Composer 008 is absent and the Graphical Renderer 007 renders on the graphical display directly not on an intermediate pixel buffer. In other embodiments the user application 001 and the Graphical Toolkit 002 might be merged into one entity or expanded into more than two entities.

The extension stub 005 takes a sequence of rendering commands and assembles them into a serial data stream suitable for transmission via the network link 011 and transmits this data stream. The extension stub 006 receives the serial data stream and disassembles it into a sequence of rendering commands suitable for the Graphic Renderer 007.

The Graphic Renderer 003 does not normally pass requests to the Surface Composer 004, via 014, since graphical output at the remote device is not normally required at the remote location. This will lessen the computation load on the remote device.

The stream of graphical rendering 011 transfers information in one direction only. This simplex transfer pattern will prevent network round-trip latency from slowing down graphical performance. The volume of data passing through the rendering stream 011 is greatly compressed with suitable techniques.

The view in FIG. 2. shows a typical screen on an ANDROID™ cellphone. The rectangular graphical display is delineated by the brackets 020 and 021. The subwindow 022 is persistent between runs of different applications. The application shown is a typical contact manager view. The subwindows 023-030 are determined by the application being run on the device. The subwindow 023 remains immutable while the contact manager is run, the subwindows 024-030 are scrolled up or down to reveal other contacts.

FIG. 3. shows the graphical makeup of one row in the contact manager. There is a raster image in a rectangular frame 040, a horizontal bar 043, and two text strings 041-042.

Description of ANDROID™

ANDROID™ is an operating system and a collection of associated applications for mobile devices such as smartphones and tablet computers. In the relatively short period that ANDROID™ has been distributed, it has captured significant market share. A notable difference to previously introduced mobile operating environments is that ANDROID™ is distributed as open source under relatively permissive usage terms, thus allowing modification and inspection of any part of the software infrastructure.

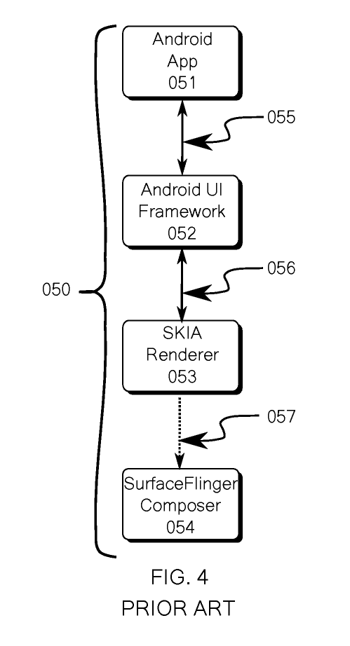

FIG. 4 shows ANDROID™'s graphical software stack 050. It should be compared to the generic graphical software stack of FIG. 7. The graphical application (app) 051 is written to an ANDROID™ specific graphical interface. ANDROID™ introduced a new GUI 052 that was based on a Java language application programming interface (API). The rendering component of the graphics stack is based on the SKIA renderer 053. The SKIA rendering library is distributed as open source software. The SurfaceFlinger 054 deals with graphical buffer allocation, double buffering and copying these buffers to the device's framebuffer. The arrows 055, 056, 057 indicate the transfer of data between the stack elements 051, 052, 053, 054.

ANDROID™ differs from other graphical rendering systems in its rendering strategy. The X11 window system uses off-screen rendering and damage notification to try to minimize re-rendering of the screenbuffer. The main rational for this is that X11 was designed to support remote graphics and is thus frugal with rendering commands. In contrast, ANDROID™ re-renders complete frames at high refresh rates. The design rationale for this behavior would seem to be the relative lack of memory and the immediacy of access to the graphics hardware. No contingency for remote graphics was contemplated.

System Diagram of an Embodiment

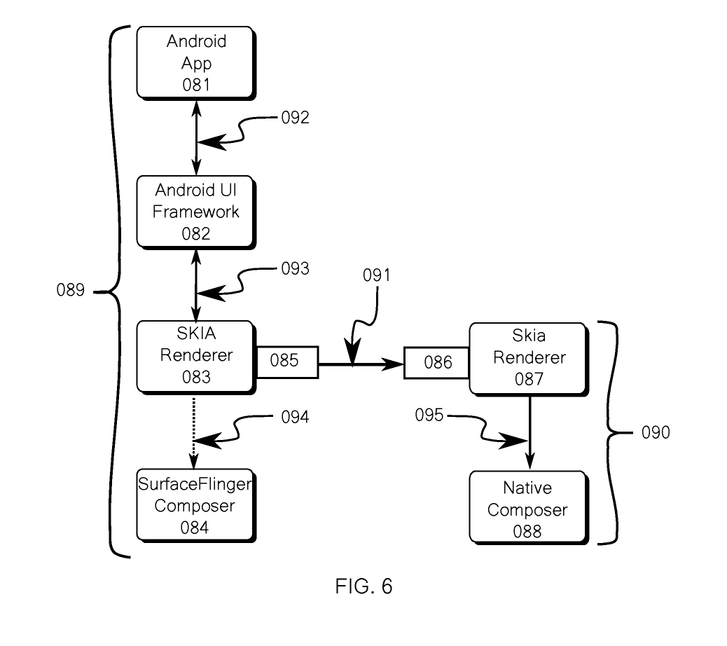

The system structure of an embodiment is given in FIG. 6. which should be compared to the more general system FIG. 1. The remote system 089, essentially runs the standard ANDROID™ graphical software stack (FIG. 4). The ANDROID™ application 081, GUI 082 and their connections 092 and 093 function as in FIG. 4. The composer 084 and its connection 094 are typically not used. The additional component added to the remote system is the extension stub 085. The extension stub 085 will assemble the rendering commands into a serial data stream. This modification to the ANDROID™ graphical software stack is facilitated by the permissive “Open Source” license used in the graphical software stack. The SKIA rendering library 083 is distributed under the Apache License, Version 2.0. This allows the source to be examined, modified, extended, recompiled and distributed. This is how the remote rendering extension stub 085 is implemented. Since the SKIA renderer 083 is a shared library, once the library with the extension stub 085 is installed, all ANDROID™ App's 081 will use the new library. Thus all applications that use SKIA, including those in the ANDROID™ Market, will then be able to be used remotely.

The local system 090, also includes an instance of the SKIA rendering library 087. Here again we use the same strategy that was used in the remote system. The SKIA rendering library is extended to create the local rendering extension stub 086. The extension stub 086 will disassemble the serial data stream into a sequence of rendering commands. The Native Composer 088 of FIG. 6 will use the native graphical composition capabilities of the local system 090 in an embodiment. Examples of capable graphical composers might be those of the X11 Window System, Microsoft WINDOWS® or Mac OS. For a native X11 graphics platform the SKIA Renderer 087 renders directly, via 095, into X11 shared memory pixmaps and then has the X11 server display the pixmap using the XShmPutImage( ) X11 Shared Memory, extension function. This approach closely parallels the functionality of the SurfaceFlinger in ANDROID™.

RPC of the Rendering Interface

Procedural interfaces can be distributed to remote locations via Remote Procedure Calls (RPC). The approach here is similar but there is one major difference. Normally RPC's have functional semantics, meaning that each call has a value returned. Implementing these semantics would impose a latency of one round trip per functional call, which would impose unacceptable overhead. On the other hand there are many times that the return value of the SKIA routine is needed. This is true for measurement frames that frequently query the SKIA renderer about the metrics of graphic elements. The way to eliminate round trip latencies is to have the remote SKIA Renderer execute the rendering commands and return values to the ANDROID™ GUI Framework on 093 (FIG. 6). The remote SKIA Renderer must execute and return values for all the commands that it receives from 082 via 093. The only thing that may be skipped is the computationally expensive actual rendering of the image since the actual rendered graphical image is normally not needed on the remote end. The graphical frame is not normally passed to the SurfaceFlinger 084. In fact the SurfaceFlinger 084 may not be needed if the remote system does not contain a framebuffer. This is the reason that in FIG. 6 the arrow 094 from the SKIA Renderer 083 to the SurfaceFlinger 084 is shown as a dotted line. The arrow 091 is shown as going in one direction from 085 the remote extension stub to 086 the local extension stub. This indicates that the network channel is one way only with no round trip delays.

The rendering interface for the SKIA rendering library 083, resides in one C++ file called SkDraw.cpp. This is the only file that must be modified to export the rendering interface. An embodiment was built that has, as the local system, a X11 program running under Ubuntu Linux. The SKIA renderer software 087 used was taken from the open source distribution from Google and need not be modified at all. The local extension stub 086 contains the main routine and uses an unmodified SKIA rendering library to render frames on the local device. Modifying both the remote ANDROID™ SKIA renderer 083 and the local SKIA renderer 087 to support remote graphics rendering confirms that remote graphics works properly and the local extension stub was equipped with the capability to dump both binary and symbolic traces of the traffic in the link 091.

Some traces of the RPC traffic are shown in 1, 2, 3, 5 and 6.

The RPC stream 011 is an unstructured sequence of procedure calls that renders a graphical frame. The only explicit control structures are the non-SKIA commands that indicate “end of frame”. This command is an indication to the local Surface Composer 008 that the frame is ready to be displayed on the local framebuffer.

LISTING 1 shows a partial part of a trace of graphic rendering commands taken from a listing of a complete frame. This code renders the graphics of FIG. 3 which represents one contact.

A complete frame contains parts or all of 7 or 8 contacts depending on how the contact list is scrolled. As the contact list is scrolled, different contacts are added and deleted to the list currently shown, and the number of contacts shown cycles between 7 and 8. As the contact list, shown in FIG. 3, is scrolled, the area of the screen delimited by 024-030 is refreshed many times a second. The areas 022 and 023 are preserved during the scrolling of the contact list. Each contact is rendered with commands that are very similar to LISTING 1. In practice, the only differences observed between different renderings of contacts are in the location of the contact in the list (line 2), the first and last names, string lengths and locations of the contact (line 13, 14) and possibly in the paint (color) of the contact names (lines 13, 14).

Redundancy in the Data Stream

Compression is based on redundancy in the data stream. Redundancy is observed both within frames (intra-frame) and between frames (inter-frame). The major intra-frame redundancy, for the example of FIG. 2, is due to the fact that each of the 7 or 8 contacts are rendered with very similar rendering sequences. The inter-frame redundancy arises due to the fact that the rendering sequence for each contact is mostly invariant between frames. The sequence of contacts is also mostly preserved between frames. It is observed that in practice, the exact same rendering sequence is sent multiple times with only the change of one global “Translate” rendering command for many frames. The rendering commands only change significantly during the morphological change from 7 contacts to 8 contacts. Even in this case, these two patterns, 7-to-8, repeats cyclically as in the sequence 7-8-7-8-7- . . . . This recurring pattern also is exploited to provide effective compression.

No Pipelining of Rendering Commands

Another characteristic of the frame rendering is that there is no significant advantage in beginning transmission (pipelining) of the graphic rendering commands from the remote extension stub 005 to the local extension stub 006 before the complete frame has been rendered. The reason for this is that the time to generate the rendering commands of a frame is less than the period (in time) of a frame. This is true in general for ANDROID™ systems and is more pronounced for the remote system 009 of FIG. 1 since the computationally intensive rendering of bits 014 need not be performed on the remote system. The remote extension stub 005 analyzes and compresses the full frame before transmission without a significant increase in display latency. The ability to analyze a complete frame before compression is performed leads to efficiencies in compression.

Unstructured Compression Techniques

Some standard compression techniques give efficient compression for this data stream. They operate on unstructured strings of tokens. Two well known techniques that are used to provide alternative embodiments for compression are statistical modeling algorithms such as LZW (Lempel-Ziv-Welch) and variants of LCS (longest common subsequence) problem.

Statistical Modeling Compression

LZW makes use of references to re-occurring sequences within the uncompressed data stream to lower the amount of data transmitted. Since large parts of the data stream re-occur both in intra-frame and between inter-frame segments, LZW provides good compression. It has been observed that zlib (a variant of LZ77) provides close to a ratio of 1:100 compression during scrolling with 7 or 8 contacts on screen and a ratio of 1:30 during the morphological transitions from 7 to 8 contacts or from 8 to 7 contacts.

A test was done compressing the original ASCII indented rendering trace from which LISTING 2 was excerpted. The uncompressed file was 691653 bytes. The bzip2 (Burrows-Wheeler transform + move-to-front transform + Huffman encoding) compressed file was 4001 bytes. This gives a compression ratio of 1:172. It should be understood that objects such as bitmaps and paint objects were not transmitted in this test. It also should be understood that the compression was done on an ASCII stream which gives better compression.

Longest Common Subsequence

LCS determines the minimal set of insertions and deletions that will convert one sequence into another. It is the basis for the well known Unix diff utility. Using this algorithm, the remote extension stub 005 determines the minimal number of changes needed to convert any previous frame to the current uncompressed frame. The remote extension stub will then perform the LCS procedure between a number of different previous frames and send the results that have the shortest sequence of changes to the local extension stub 006. The local extension stub 006 will cache copies of the previous frames that are used by the remote extension stub 005 for the LCS comparisons. The reason that more than just the previous frame is used in this LCS procedure is that older frames might be morphologically closer to the current frame than the previous frame sent. This could happen in our example of FIG. 3 when there is a 7 contact frame to 8 contact frame transition. If the previous 8 contact frame from the previous 7-8-7-8- . . . cycle has been stored, the LCS sequence from the 8 contact frame might be shorter than the LCS derived from the previous frame.

One significant disadvantage of LCS is its computational complexity which is solvable in polynomial time by dynamic programming. The entropy encoding (LZW, LZ77, Burrows-Wheeler) techniques are, in comparison, computationally more efficient.

Structured Compression

In the previous compression schemes, the RPC stream was treated as an unstructured linear stream of symbols. Implicit information transferred via the RPC stream exposes much of the structure of both the remote App 001 and the Graphical Toolkit 002. This structural information occurs since the ANDROID™ UI Framework generally brackets high level graphical objects with Save/Restore procedures before performing graphical rendering of those objects. This is to allow simple restoration of the graphic state to its value before invocation of the routine that performed the rendering. A simple example is given taken from LISTING 1, lines 1, 2, 3, 4 and 39. It can be inferred that the remote application/toolkit has entered a routine that will first draw a rectangle at location (0.0, 244.0) and then proceed to do further rendering (LISTING 1, lines 5-38). Practically speaking, the origin of the coordinate system has been changed (LISTING 1, line 2) and the allowable region of rendering (LISTING 1, line 3) has been narrowed. The original origin of the coordinate system and the allowable region of rendering is restored in LISTING 1, line 39. The further rendering (LISTING 1, lines 5-38) now has a current graphics state with a new transformation matrix (changed in LISTING 1, line 5), origin (changed in LISTING 1, line 6) and clipping mask (changed in LISTING 1, line 7).

The Save/Restore balanced pairs is used to derive higher level programming structure. The LISTINGS 2, 5 and 6 all Save( ) and SaveLayer( ) routines have had “{” prepended to the trace. All Restore( ) routines have had “} ” appended. The traces then have a programmatic structure similar to the C programming language. The indentation of the traces are a result of running the trace through a standard C programming language indentation utility.

The rendering trace of LISTING 1 is a linear representation of the programmatic rendering routines as they are executed. Some of the original nested functional structure is recovered by the simple transformation described above as shown in LISTING 2.

Functional Transformation of LISTING 2

The transformation of LISTING 2 from nested control sections to a fully functional representation is shown in LISTING 3. The routines have been arbitrarily named contact“n”( ), with “n” being assigned sequentially as the routines are encountered. The notation in LISTING 3 is very close to C programming language with some exceptions. The notation “[Left, Right, Top, Bottom]” (e.g. LISTING 3, line 4) represents a rectangular object. Numbers that are written in hexadecimal notation (e.g. 0xff333333) reference objects on the remote server which are currently in the local object-store. These objects might be paint objects, bitmap objects, rectangle objects or path objects. They are serialized and sent from the remote side 005 and stored on the local side 006. Once they are stored on the local side, they are referenced by the remote address and a local reference is returned for the SKIA calls on the local machine. The local object-store is managed by the remote side. If an object has to be deallocated because of memory management considerations, the remote side will send a command to deallocate the object. This allows the remote side to know which objects are in the local object-store. It is important that the remote side knows exactly which objects are stored at the local end since the communication link 011 is one way (simplex), thereby minimizing round trip delays. The remote server uses a cryptographic hash function, such as MD5, to verify that objects have not changed from the value currently in the local object-store before commands referencing them are sent to the local system, thereby minimizing the unnecessary transmission of large objects.

Analysis of LISTING 3

An analysis of the code in LISTING 3 reveals many things about the running application 051 and the ANDROID™ UI Framework 052. The routine contact0( ) (lines 1-8) is the routine that renders FIG. 3. The Translate( ) (line 3) command will move the graphics of FIG. 3 to the location on FIG. 2. labeled 027. The ClipRect( ) (line 4) will assure that graphics do not appear outside the rectangle on FIG. 2. labeled 027. The DrawRect( ) (line 5) command will draw a rectangle that is 320 units wide and 2 units high. This is the line labeled 043 in FIG. 3. The routine contact1( ) referenced in line 6 draws the string “Mandy Smith” 041-042 at the translated location (line 11). The string is printed as two words (lines 29, 30) since the color of the strings, as determined by the paint argument of DrawText( ) changes independently as the contact list is scrolled to indicate the sorting order. The two rectangles (lines 22, 23) do not appear because the paint parameter has a transparent color (0×0) as opposed to the rectangle (line 4) with paint color 0xff333333. The image 040 is rendered by the contacts( ) routine. The lines 36-44 render nine rectangles which correspond to the NinePatch ANDROID™ GUI class. As described in the ANDROID™ documentation:
“The NinePatch class permits drawing a bitmap in nine sections. The four corners are unscaled; the four edges are scaled in one axis, and the middle is scaled in both axes. Normally, the middle is transparent so that the patch can provide a selection about a rectangle.”

The image that corresponds to the contact is then rendered (contact6( ) ) into the “picture frame” created by the NinePatch routine (contact5( ) ). The image is scaled by a factor of ⅞ (line 50) during rendering.

Separation of Control from Data

The next transformation is conceptually simple but somewhat difficult to demonstrate in a listing because of its notational complexity. The idea is to separate the functional (control flow) from the data. In LISTING 3, there are many constants and subroutine calls in each defined subroutine. For the trace in LISTING 3, the data items are 7 subroutines, 28 rectangles, 9 bitmaps, 21 paints, 2 strings, 9 integers and 23 floating numbers. In LISTING 4, the simplest subroutine contact6( ) has been transformed to separate the control from the data.

The routine contact0( ) will have as arguments 6 subroutine references (pointers to subroutines), 28 rectangles, 9 bitmaps, 21 paints, 2 strings, 9 integers and 23 floating numbers. The separation of the data from the functional control flow will make the routines much more general and allow their re-use. For the example in LISTING 4, contact6( ) will draw any bitmap, at any location, with any affine transformation applied. In LISTING 3, contact6( ) will only draw a specific bitmap, at a specific location, at a scaling of ⅞. The transformed contacts( ) will then render any NinePatch bitmap having any configuration. The large number of arguments to these routines are not impractical since all the routines are generated and executed by computer algorithms which can keep track of the large number of arguments.

LISTING 3 represents only part of the frame. The “main” routine of each frame will have 7 or 8 routines each of which are similar to LISTING 3.

Intra-Frame Compression

LISTING 5 shows the trace immediately following the trace of LISTING 2. It renders 028 (FIG. 2). LISTING 5 could be transmitted from the remote system 089 to the local system 090. This would be wasteful of the bandwidth 091 since only three lines are different as shown in TABLE 1. The first change to line 2 is to position the new contact entry 64.0 units lower on the display. The second change to line 13 changes the first name of the contact and the size of the string. The third change to line 14 changes the location of the string. Thus, to execute the code in LISTING 5, we transmit only the five changes of parameters and re-execute the previous routine (contact0( . . . )) with only these five arguments changed. This is a type of intra-frame compression.

A similar concept appears in the MPEG (Motion Picture Expert Group) standard which defines intra coded compressed frames called, I-frames, that are reconstructed without any reference to other frames. The technique used to compress I-frames in MPEG is similar to the techniques used in the JPEG standard.

It should be appreciated that the MPEG standard deals with pixel based compression in contrast to the current invention. The techniques used in MPEG are useful in pixel based remote graphics systems such as VNC.

Inter-Frame Compression

LISTING 6 shows the rendering trace for the contact “Mandy Smith” in the next frame after the contact “Mandy Smith” moves up one location in the list. Only one line in this trace is changed, as shown in TABLE 2. This change moves the contact entry up 42.0 units. All that is needed to re-render this contact in the next frame is to change one parameter and to rerun the previous rendering commands. In order to re-render the next contact “Paul Smith”, only one change is needed to the same rendering sequence from the previous frame. The parameter 308.0 in line 2 of LISTING 5 should be changed to 266.0. In ANDROID™, the intensity (color) of the non-sorting name is in some instances dynamically changed as the contact list is scrolled. This would result in a simple change to the color black (0xffffffff) in line 13, which in this case is the non-sorting string. This is a form of inter-frame compression and is used after the initial version of the desired graphics has been rendered in a previous frame.

A similar concept appears in the MPEG (Motion Picture Expert Group) standard which defines inter coded compressed frames called, P-frames. The P-frames are forward predicted from the last I-frame or P-frame, i.e., it is impossible to reconstruct them without the data of another frame (I or P). Here again it should be appreciated that the MPEG standard deals with pixel based compression in contrast to the current invention.

Functional Parameterized Compression

The remote extension stub 085 (FIG. 6) and the local extension stub 086 share information via a one way data link, 091. Both extension stubs have a set of data structures that must remain coherent. These data structures, from hereon the “dictionary”, contain sequences of rendering routines that build up incrementally as rendering traces are sent over the data link. As each routine is completed, it is added to the dictionary and assigned a serial number, that is the same in both the remote and local extension stubs. The dictionary also contains the data arguments from previous rendering traces. When a new rendering sequence with balanced save/restore delimiters is received from the Graphics Render 083, a dictionary lookup is performed to check if this control sequence is in the dictionary. If it appears in the dictionary, then the data sequences from previous invocations of this control sequence (routine) will be searched for the closest match. The sequence number of the routine, the sequence number of the data set, and the differences between the data arguments are then transmitted to the local extension stub. The local extension stub then executes the rendering commands. Both the remote and local extension stub then insert the new data sequences into their dictionary and remain consistent. If the control sequence is not found, then the actual rendering trace is sent to the local extension stub, and both the control sequence (routine) and the argument set are entered into the dictionary and executed.

Resolution Independence

SKIA graphics is largely resolution independent except for bitmaps. Bitmaps are transformed and resampled upon rendering by SKIA. Thus, local SKIA graphics are independent of the remote device's display resolution, a fundamental difference from bitmapped based remote X11 graphics. The rendering stream will render properly when sent to devices with different display sizes or pixel density.

3-D Graphics

In ANDROID™, 3-D graphic rendering is done with OpenGL ES. Similar techniques are able to provide remote graphics in the 3-D case. The major difference is that in the 3-D case the rendering interface (OpenG1 ES) API is exposed to the user application and its usage is more variable. For 2-D rendering the SKIA libraries are not exposed to the user application so the SKIA usage is more consistent. For this reason structured compression is not always possible. For 3-D rendering unstructured compression can be used.

### Alternate Embodiment

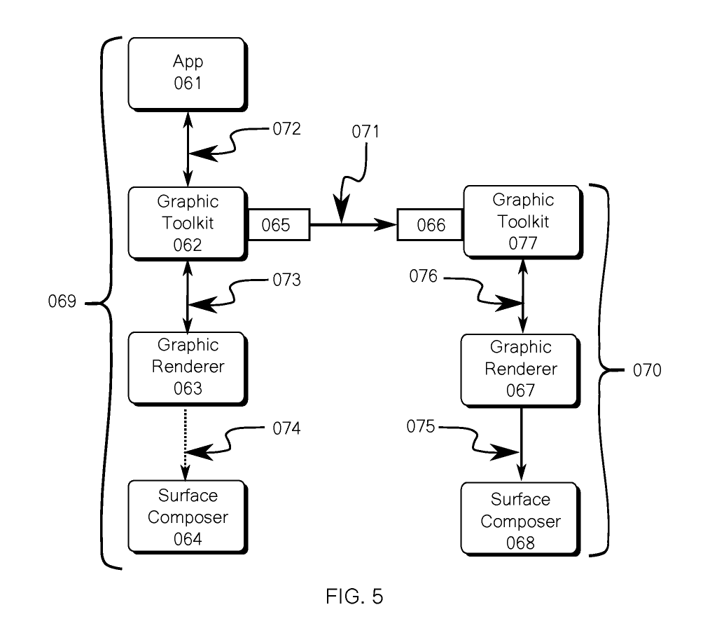

The system in FIG. 5 shows an alternate embodiment in which the remote procedure calls (RPC) are inserted at the graphical toolkit 062 level. The remote system 069 with components 061-064 and 072-074 functions as in FIG. 6. The remote extension stub 065 and the local extension stub 066 communicate via the 071 network channel. Conceptually, this system operates similarly to the system of FIG. 6. It has the disadvantage that the ANDROID™ graphical toolkit 062 API is much more complex than the SKIA renderer 063 API. A more serious difficulty with this approach is that the graphical toolkit 062 API is very variable between versions and even subversions. Any small difference between the GUI API's supported on either side, 062 or 077, will make the RPC protocols incompatible. The SKIA graphic renderers 063 and 067 are much more stable between versions of the system. It is possible that the system of FIG. 5 might be more efficient than the system of FIG. 6 with respect to data transmission via the link 071.

Description of Computer Program LISTINGS 7-20—Data Structures

The LISTINGS 7-20 contain a complete program that will parse and compress rendering traces such as those found in the LISTINGS 1, 2, 5 and 6. This program was written for Ubuntu Linux and uses the standard -lssl library for MD5 checksum computation. It has been written with a goal of clarity rather than for maximum efficiency. It assumes that memory is infinite and thus does no memory management. It uses no binary encoding and stores everything in ASCII strings.

Data Structures

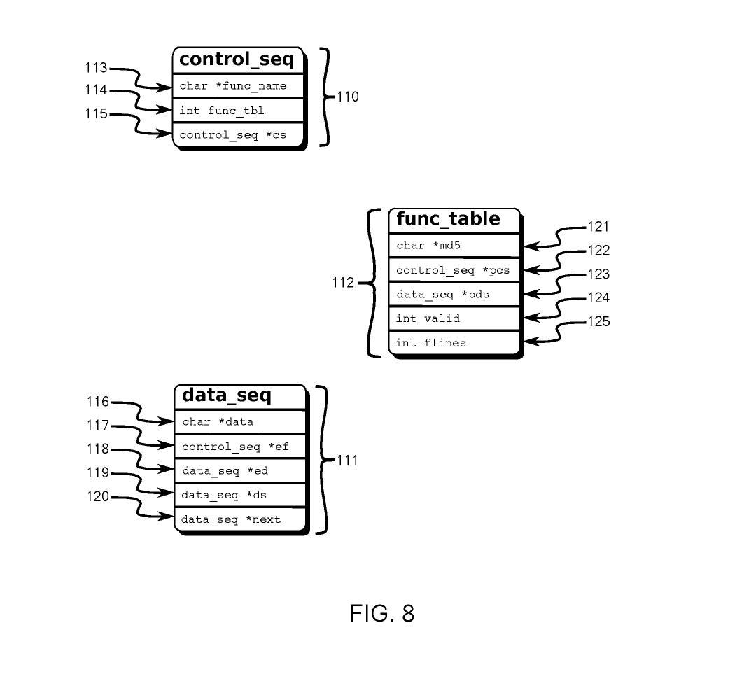

There are three data structures 110, 111 and 112, shown in FIG. 8, that are used to internally store the rendering traces:

The control_seq structure, 110, is used to store a control sequence. A control structure is a sequence of rendering instructions. Each rendering instruction is stored as an ASCII string in 113. A null string (denoted “->function” in the LISTING 22) indicates a jump to a “subroutine” that is defined in the paired control sequence 117 and data sequence 118. The index 114 is only valid in the first control_seq of the linked list and it indicates the entry in the func_table 112 that corresponds to the linked control structure. The control_seq link 115 points to the next control instruction and is used to create a control sequence.

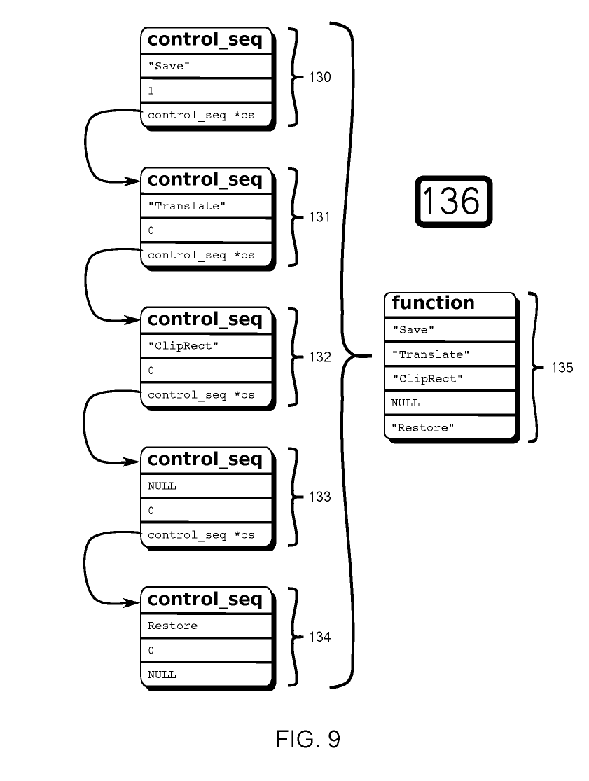

FIG. 9 shows the control sequence that corresponds to the function contact1( ) in LISTING 3. The label 136 represents the whole of FIG. 9. Every element in the control sequence 130-134 is linked. The last element 134 has a NULL link. An abbreviated representation of the 5 linked control_seq's 130-134 is represented as 135. The control structure 133 has a NULL pointer which means the paired data structure contains the corresponding control-data pair.

The data_seq structure, 111, is used to store a data sequence. The immediate data string is 116. The paired pointers to an indirect control-data sequence are in 117 and 118. The pointer to the next data element is 119 and the pointer to the next data sequence is 120.

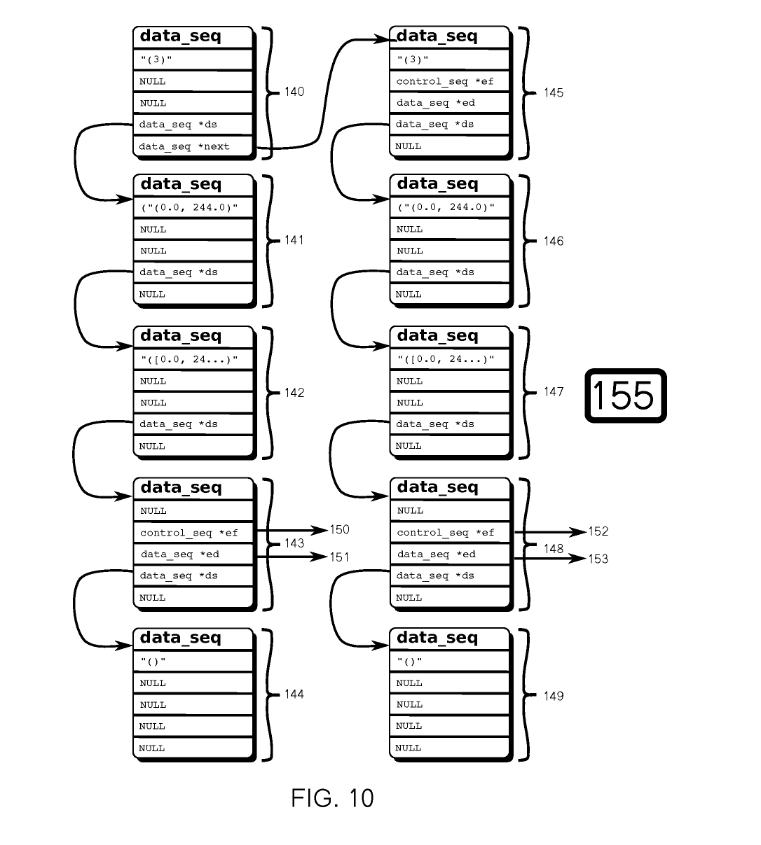

The data_seq structure, is always paired with a control_seq structure. The rational for two separate structures is to separate the control from the data as was discussed above. FIG. 10 has two linked data sequences corresponding to two invocations of the function contact1( ) in LISTING 3. The label 155 represents the whole of FIG. 10. The first data sequence is 140-144 and the second is 145-149. If the data field 116 is not NULL, then this field contains the parameters to the invocation of the rendering function of FIG. 8 113. If the data field in FIG. 8 116 is NULL, the corresponding func_name field in FIG. 8 133 is also NULL. This means that the rendering instruction is a call to a user function. In this case the pointers 150 and 151 (or 152 and 153) point to the control_seq and data seq, respectively, which are then executed.

FIG. 8 112 shows the func_table structure. The function table is built from an array of these structures LISTING 7 lines 24-30. This table has an entry for each of the unique control sequences (functions) that have so far been encountered in the rendering stream. FIG. 8 121 is the MD5 cryptographic checksum of 122 that is used to rapidly check control sequences for identity. FIG. 8 122 is a pointer to the control sequence that represents this function table's entry. FIG. 8 123 is a pointer to a list of data sequences. Each data sequence has been rendered in the past. FIG. 8 124 indicates if this entry is valid and has thus been assigned. FIG. 8 125 gives the length of the control sequence.

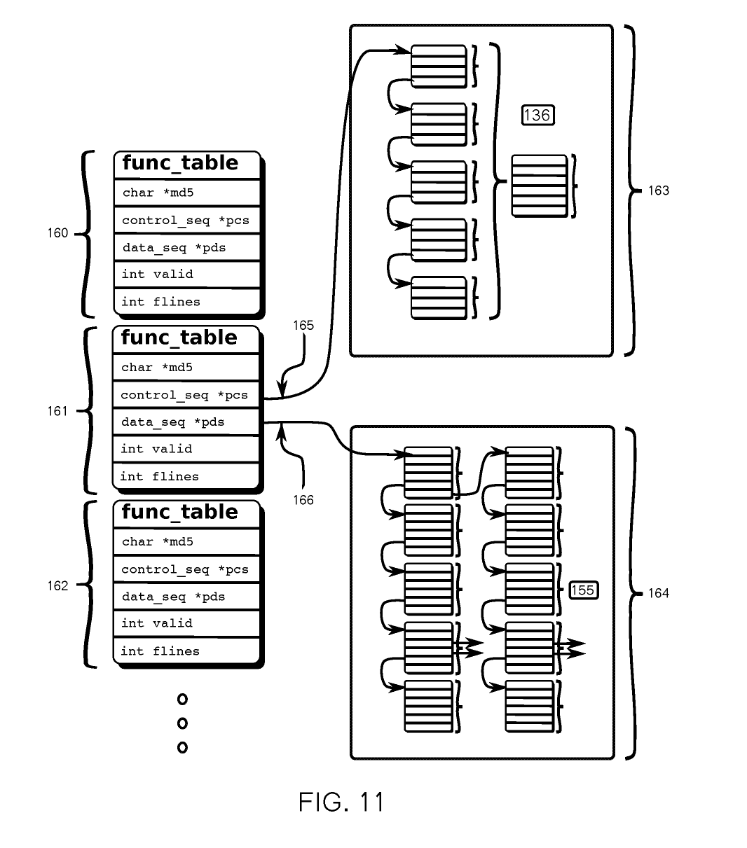

FIG. 11 shows the overall interactions between the three data structures. The function table is defined as an array of func_table structures. The first function (e.g. contact0( ), LISTING 3, line 1) is shown in FIG. 11 160. The second function (e.g. contact1( ), LISTING 3, line 9) is shown in FIG. 11 161. The third function (e.g. contact2( ) LISTING 3, line 15) is shown in FIG. 11 162. The entry for contact1( ) 161 shows the link 165 to the control sequence (the contact1( ) function) as shown in FIG. 9. 164 The link 166 points to a list of data structures. The label 163 is FIG. 9. and the label 164 is FIG. 10. Each data sequence (vertical linked list) is a record of the data sequence of a previous invocation of the control sequence (the contact1( ) function). This list gives the complete history of all previous uses of function and the data used in each invocation. The structure shown in FIG. 11 is the implementation of the dictionary that is coherently maintained on the remote and local ends.

Summary of Algorithm

Here is a general summary of the main algorithm LISTING 17. Some details of the actual code, LISTINGS 7-20, have been left out for simplicity and “boundary conditions” have been ignored for simplicity in this discussion. The algorithm (get_cs( ) LISTING 17 line 255) proceeds as follows:

1) Initialize the first control_seq and data_seq structures (LISTING 17 line 268-277).

2) Acquire the next function,data pair (LISTING 17 line 279).

3) If the function is a “Save” or “SaveLayer” (LISTING 17 line 280) recursively call the algorithm (LISTING 17 line 283) and save the control (LISTING 17 line 289) and data (LISTING 17 line 290) returned in the data_seq (the ef and ed fields) and zero out the data field.

4) Otherwise add the function and data pair to the control_seq and data_seq structures (LISTING 17 line 293-305).

5) If the function is a “Restore” (LISTING 17 line 307-321), enter the control sequence into the function table if this function has heretofore not been seen. If the function is unique, with respect to all the entries in the function table, transmit the function to the remote end. Select the closest data sequence of previously used data sequences 166. If there is a previous matching data sequence transmit the serial number of the data sequence and the diffs needed to create the new data sequence, otherwise transmit the whole data sequence. Return the control-data sequences.

6) Go to step 2 to get the next control-data render command (LISTING 17 line 279).

This is the description of the routine that parses the input, which is an ASCII rendering trace. The other parts of the program are mostly utility routines and the main routine.

LISTING 7

This listing contains the data structures definitions that have been previously described.

LISTING 8

This listing contains the skeletons for the data transfer routines. This listing also contains the scanchar( ) routine that inputs characters and ignores white spaces.

LISTING 9

This listing contains the getfunc( ) routine that returns the control function and associated data as two ASCII strings. It corresponds to the lexical analysis section of the parser.

LISTING 10

This listing contains the calc_hash( ) function that returns the MD5 checksum of the control sequence.

LISTING 11

This listing contains the cmd_lines( ) function that returns the number of lines in the control sequence.

LISTING 12

This listing contains the store_func( ) function that enters a control sequence in the function table. It checks first if this control sequence has been previously seen before storing the control sequence.

LISTING 13

This listing contains the print_cs2( ) function that prints a control sequence. It prints the rendering command if the func_name member is not NULL, otherwise it prints the “->function” string.

LISTING 14

This listing contains the add_stats( ) and print_stats( ) routine that adds and prints cumulative statistics.

LISTING 15

This listing contains the diff_func( ) that finds the closest data sequence from a list of previous data sequences. It will send to the local system the shortest representation of the data sequence.

LISTING 16

This listing contains the print_cs( ) routine that recursively prints both the control and data sequences. It traverses the control sequences until it encounters a link in the data, LISTING 16, line 243. It then calls itself recursively, LISTING 16, line 244. The rendering commands and data are traversed in the same order as the original rendering stream. A routine with the same structure with the printf's removed and rendering routines inserted will execute the rendering stream. This is how the rendering stream is executed on the local machine.

LISTING 17

This listing contains the get_cs( ) routine which is the main parsing routine. This algorithm has been previously described under the SUMMARY OF ALGORITHM header. The structure of this routine is that of a recursive descent parser. It generates the control-data sequences in top-down order. The order that the control sequence routines are returned and stored are different from the human bottom-up approach used to produce LISTING 3.

LISTING 18

This listing contains the func_num( ) function. It returns the index of a control sequence in the function table.

LISTING 19

This listing contains the print_func_tbl( ) routine. It prints the control sequences of the function table. The two arguments printed as the function's parameters are the number of lines in the function and the number of times the function has been called.

LISTING 20

This listing contains the main( ) routine. It loops through the rendering frames (LISTING 20, lines 371-372) and prints the cumulative statistics (LISTING 20, lines 373). After the input is exhausted, the function table is printed.

Compression of Rendering Traces

The program of LISTINGS 7-20 will accept as input ASCII formatted rendering traces. A rendering trace of a 60 frame sequence for the application shown in FIG. 2 was captured. The first 60 lines of output from the program of LISTINGS 7-20 that was run on this captured rendering trace is shown in the two columns of LISTING 21. Headings have been added to make the output more understandable. The last line (LISTING 21, line 60) gives cumulative statistics for the complete 60 frames.

Of the 13702 rendering commands there were 2691 functions (command sequences or Save/Restore pairs). Of these only 47 were unique. Only these 47 command sequences need by transmitted to the local client. This gives a compression ratio of % 0.34 (about 1:291).

There are 13702 rendering commands of which 354 had completely unique data parameter sets and 203 had data sets that are partially different. Only these 557 data sets have to be transmitted which gives a data compression of 4.06% (about 1:25). If the partially different data sets are differentially transmitted a data compression of 3.3% (about 1:30) is obtained.

An examination of the first frame (LISTING 21, line 1) shows that even for the first frame the intra-frame compression is effective in reducing data transmission. Of the 39 functions of the first frame only 14 are unique and of the 190 data parameter sets only 115 need to be transmitted.

An examination of the last 10 frames (LISTING 21, line 51-60) shows that of these last 10 frames only one partially different data set has to be transmitted. This is because data compression becomes more effective after the scrolling of the contact list returns to areas that have previously been seen. This does not include some fixed per-frame overhead.

Compression of LISTINGS 2 AND 5

The program of LISTINGS 7-20 can be run on the concatenation of LISTINGS 2 and 5. The complete output of this command is shown in LISTING 22. This input will be parsed as two frames by the program. The first two lines shows the cumulative statistics of the two frames. There are a total of 7 functions in the first frame. These correspond to the 7 functions in LISTINGS 3. The second frame has the same 7 functions and thus no new functions are sent. The 39 data sequences in the first frame correspond to the 39 lines in LISTINGS 2. The 3 differences in the second frame are those shown in TABLE 1. The naming of the functions in LISTING 22 is different than those of LISTING 3. TABLE 9 shows the correspondence between these two mappings. The notation “->function” such as in LISTING 22 line 13 signifies a jump to an indirect subroutine that is specified in the corresponding entry of the data sequence (FIGS. 8, 117 and 118).

Entropy Encoding

In addition to the compression introduced by the program of LISTINGS 7-20 additional compression can be obtained by entropy encoding of the transmitted stream. The transmitted stream contains two major components, functions and data.

The functions, in the 60 frame sample, are composed of streams of rendering commands having the frequencies shown in TABLE 10. The entropy of this distribution is given in the last line of the table. This gives a lower bound on the best average bit encoding of a stream of these 14 rendering commands having the given frequency histogram. Using the Huffman coding algorithm for the code frequencies given in TABLE 10 the average bit length per command is 3.61 bits.

The data stream is composed of a stream of 32 bit integers and floating point data. There are 51786 data arguments of which only 185 are unique. The entropy value of this distribution gives 4.70 bits per data code. Using the Huffman coding algorithm on the data stream gives an average value of 4.89 bits per data item. This gives a compression of 15.2% (about 1:6.5).

Given the combination of the compression of LISTINGS 7-20 and Huffman coding the total compression ratio is considerably over 1:100.

Consolidation of Indirect Subroutines

A further optimization can be done by rewriting functions with consecutive “->function” entries such as LISTING 22 lines 58 and 59. These two lines will be replaced with one “->function” line. The indirect subroutine (FIGS. 8, 117 and 118) can then represent a sequence (or list) of routine pointers. A test of this change will decrease the 47 different functions of LISTING 21 to 27. This optimization will take routines that act on list of objects and “telescope” many control traces into just one.

Number of Control Sequences Per Compiled Function

For every compiled function that executes rendering functions and that has a balanced opening Save( ) and closing Restore( ) functions, there is at least one observed control sequence trace. If there are no statements that alter the control flow then the functions are executed in a linear deterministic fashion and the number of generated control sequence traces is exactly one. Every simple control flow statement (e.g. if, if-else) potentially can potentially increase the number of control sequences by a factor of two. Thus a routine that has three “if” statements might generate up to eight different control sequence traces. The actual number of control sequences is frequently less than the maximum since not all possible execution paths are actually taken. Also even if two different paths are taken, and if the only difference is that different user functions are called, the control sequence remains the same and the difference is reflected only in the data sequence,

More complex control structures, such as loops, can potentially generate an unbounded number of control sequences. In these cases strategies such as the above mentioned “telescoping” transformation can deal with reducing the number of control sequences to one per loop.

The “nesting” structure of GUI programming is well supported by the structured compression algorithm of LISTINGS 7-20. Widgets such as the list widget has a number of other widgets that are linked into the list. In turn each element of the list widget is a composite of a number of widgets. The number of elements of the list widget might be large and each of these elements might be a different composition of widgets. Nevertheless only one control sequence can cover the many possibilities of the list widget, given the proper optimizations.

Visual Perception Theory and Inter-Frame Compression

Visual perception theory constraints the likely characteristics of the frames (images) that typically are presented to the GUI user via a graphics display. Based on visual perception theory, it would seem that good inter-frame compression is generally possible on visual frames of a computer-human visual interface.

The first element of visual perception theory that is of interest is when frames are presented above a certain frame rate the eye perceives an absence of flicker. This effect is called “Persistence Of Vision” and is the basis for the natural look of motion films. Frames presented at a rate of more than 45 per second are perceived without distracting flicker. This is the rationale of screening motion pictures at 24 frames per second. Each frame is shown twice, while the shutter interrupts the image 48 times a second. This is the reason that displays usually have a display frame refresh rate of more than 50 frames per second.

The second element of visual perception theory of interest is the phi phenomenon, a neuro-physiological optical illusion based on the principle that the human eye is capable of perceiving apparent movement from pieces of information, such as a succession of images. If a series of images, each one slightly different, is presented at a sufficiently fast rate, the human visual system will interpolate smooth motion between the images. This effect is seen at much lower frame rates than the persistence of vision threshold, often 10 frames a second is sufficient. Quickly changing the viewed image is the principle of an animatic (an animated storyboard), a flip-book, or a zoetrope. In drawn animation, moving characters are often shot “on twos”, that is to say, one drawing is shown for every two frames of film (which usually runs at 24 frames per second), so that there are only 12 drawings per second. This frame rate is sufficient for “Saturday morning cartoons” and is common in commercial stop motion animations. For a human-computer graphics stream that is to be perceived to have “smooth” movement, a theatrical frame rate of 24 frames per second is sufficient and a lower rate might be tolerable. Thus, the graphic rendering system typically delivers new frames at a rate less than the graphical display frame refresh rate.

Most graphical GUI's are based on models that mimic our everyday visual experience. For example, lists of items are modeled after the rolling of scrolls (i.e. scrolling), paging text might be modeled after the turning of a page in a book, and browsing photographic images might use the cover flow paradigm. The common factor between all these graphical effects is a reliance on the phi phenomenon to stimulate smooth apparent motion. In order for this optical illusion to work smoothly the difference between consecutive frames must be small, thus a large number of similar frames should be seen evolving slowly. Every few seconds, an abrupt transition to a new GUI image may occur, which then slowly evolves for a large number of frames. Generally, the inter-frame compressibility of GUI rendering sequences is quite high.

Similar analysis and assumptions underlies the MPEG video standard's inter-frame compression algorithm which uses motion compensation of the pixel data to encode inter-frame changes compactly. The reason that this compression strategy is so successful for video streams, is that frame sequences typically evolve slowly with large areas of the image moving coherently. The common thread between MPEG and the current invention is that, in both problem domains, the moving images convey apparent smooth motion by exploiting the phi phenomenon and thus have constraints on the image sequences dictated by the physiology of human visual system. These constraints are exploited in the compression algorithms

Imported and Exported Services

Besides remote graphics that are imported from the remote server, a number of ANDROID™ system architecture components must be exported from the remote server or imported to the remote server. Some services are:

Camera Driver

Audio Drivers

Keypad Driver

Touchscreen Driver

Location Manager

For example: Audio output might be exported from the remote server to the local client. Audio input might be imported to the remote server from the local client. The location manager service might reside on either the remote server or local client for co-located devices, but for spatially separated devices the location manager might reside on the local client and import this service to the remote server.

It should be appreciated that interaction with these services will possibly incur round trip latencies. Thus for the touchscreen services, the latency between the “touch” and the graphical interaction is at least a round trip delay.

The ANDROID™ Lifecycle

A standard ANDROID™ application has a lifecycle that can cycle through active-paused-stopped states. While in the paused or stopped state, the application can be dropped from memory, equivalent to killing the Linux process. Such behavior is reasonable for a memory strapped-mobile device that displays one application at a time. The standard ANDROID™ lifecycle should be modified to that of a Linux application for an ANDROID™ application running on a standard Linux server. Normal Linux applications, on large memory and disk backed machines, are never terminated arbitrarily (Out Of Memory (OOM) termination is an exceptional condition). Idle applications gradually lose all their resident memory pages by being swapped out to the backing store, but can be swapped in to continue execution at any time.

A generic local ANDROID™ application allows remote applications to be launched. Such a generic application will display the remote application and pass local input interaction back to the server.

Example System Configurations

There are many possible variant-configurations of the system of FIG. 1. TABLE 3 shows a blank table that is used to categorize a particular system configuration. Each row of the table shows one category. Some categories, such as 200 and 203, apply to both the remote 205 (cf. FIG. 1, 009) and local 206 (cf. FIG. 1, 010) systems. Other categories are applied separately to the remote and local systems.

a. Spatially Separated vs. Co-located Devices—TABLE 3, line 1, 200
The remote and local devices may be either in close proximity or geographically separated. Besides other possible differences, geographically separated devices will return different results to queries of the Location Manager.
The level of service of data networking between the two devices is usually dependent on their proximity. Closely positioned devices can communicate via short range direct techniques (Wi-Fi Direct, Bluetooth, USB). Direct communications usually has low latency, variable throughput depending on the physical data link media (Bluetooth vs USB) and sometimes environmental (Wi-Fi, Bluetooth) interference. Geographically separated devices, on the other hand, will use some type of long haul networking (3G, 4G, DSL, cable, WiFi) with higher latency, variable throughput and variable quality of service.

b. Same vs Different Operating Systems—TABLE 3, line 1, 201
Both the remote and the local devices might be running the same operating system or they might be running different operating systems.

c. Mobile vs Fixed—TABLE 3, line 1, 202
Both the remote and the local devices might be geographically mobile or geographically fixed.

d. Single Window vs Multiple Windows—TABLE 3, line 1, 203
In a standard multi-window (MS WINDOWS® or X11) system, each application maps to its own window. Other systems, such as ANDROID™, normally gives a view of one application at a time.

e. Same vs Different Computer Architecture—TABLE 3, line 1, 204
Since the remote and local devices communicate via a well-defined protocol, remote and local devices running on different computer architectures simply inter-operate. For example, the remote device might be an Intel server and the local device, an ARM smart-phone. Here ARM or Intel are two examples of many possible computer architectures.

There are 8 parameters in each configuration table. If each parameter were binary, then there are potentially 256 different configuration variants. Not all parameters are binary so the number of possible variant systems is larger that 256. Not all variants are of interest, but many are.

Some example systems of interests are now shown:

a. Remote ANDROID™ Server with Local ANDROID™ Client
TABLE 4 describes the configuration of an ARM/Intel based server that functions as a remote ANDROID™ application engine serving a local ANDROID™ device:
This configuration is of interest since it runs standard ANDROID™ apps at a remote location while displaying the graphical results on the local ANDROID™ device. For scaling efficiency, the remote server runs a large-scale optimized Linux system. The ANDROID™ environment is provided by a native ANDROID™ execution environment running under a standard Linux system. The physical graphical display of the ANDROID™ execution environment are not needed for this application; their omission will save computational and electric power.

b. Remote Non-ANDROID™ Server with Local ANDROID™ Client
TABLE 5 describes the configuration of an ARM/Intel non-ANDROID™ based server that functions as a remote application engine serving a local ANDROID™ device.
There really is no reason that the remote application has to run as an ANDROID™ application. An ANDROID™ compatible graphics layer is sufficient to display remote graphics on the local ANDROID™ device. In general, any graphics software that uses the SKIA graphics rendering library is compatible with remote-local ANDROID™ graphics. An interesting potential candidate is the Chrome web browser which uses SKIA for nearly all graphics operations.

c. Remote ANDROID™ Server with Local Non-ANDROID™ Client
TABLE 6 describes the configuration of an ARM/Intel ANDROID™ based server that functions as a remote ANDROID™ application engine serving a local Non-ANDROID™ mobile device.
The Remote server might be geographically separated from or co-located with, the local client. This configuration is useful in running ANDROID™ applications on non-ANDROID™ phones. Running ANDROID™ apps via a remote protocol on an Iphone or Symbian moble device is quite practical.
Another example of this configuration would be a non-ANDROID™ set-top box. Here there might be good network connectivity but the set-top box can not directly run ANDROID™ applications. Using a remote graphics protocol will allow the set-top box user to run ANDROID™ applications.

d. Two ANDROID™ Devices
TABLE 7 categorizes two co-located ANDROID™ devices. A good example of this class of devices might be a co-located ANDROID™ mobile phone (server) and an ANDROID™ tablet client. The local ANDROID™ client might be fixed part of the time, as in a standard desktop device, or might be mobile at other times (e.g. tablets). Besides the greater size of the tablet display, there are other advantages to this configuration:
The app might be licensed to run only on the phone.
The phone's internet connectivity is used in the app.
The app's graphical interface can be made to migrate to the client and to return to the server at any time.

e. ANDROID™ Server and Desktop Client
TABLE 8 categorizes a ANDROID™ server and a desktop client: A good example of this class of devices might be a mobile ANDROID™ phone (server) and a general purpose desktop machine (client). The client might be a tablet, laptop or a fixed desktop running a well-known multi-window graphical interface. The apps on the ANDROID™ device can be mapped to one window on the client as they are mapped via the SurfaceSlinger on the ANDROID™ device. The other possibility is that each server app can be mapped to a separate window on the client's windowing system, as is expected from a desktop windowing system.

USE CASES

The previous system configurations are used to provide a wide array of remote graphic end user services.

Cloud Services
There is an interesting dichotomy between distributed cloud computing and local mobile apps. They would seem to be mutually exclusive. In a purely cloud computing environment like ChromeOS, there is no possibility of installing local applications from ANDROID™. On the ANDROID™ system, apps are both installed and executed on the local device.
There is an advantage in being able to run ANDROID™ apps in the cloud. The local device will display an application that is running on the remote server. Any ANDROID™ app can be run on the server. Thus many of the apps in the Google ANDROID™ market can be used as is. It is not necessary that the remote server and the local device have the same architecture, i.e. an Intel server can provide services for an ARM device. A simple example is the standard ANDROID™ contact manager running on the, possibly ARM, server. The contacts will then be the complete contact information of the organization that is running the server, thus allowing the most current corporate contact database to be accessed without having to sync the contacts—a security risk since devices may be lost or stolen—into the mobile device. One large corporate server should be able to support hundreds of concurrent ANDROID™ apps.
Another possibility is to provide data storage that is private to each client, possibly with a private chroot environment for each client. In this configuration, each local client would have private contact lists.
If a Google Maps application runs on the remote server. In this case, it is clear that queries of the location manager originating on the remote server have to be executed on the local device and returned to the remote server. Input (keys and touchscreen) must be performed locally and sent to the remote server. In addition, audio from the application (e.g. turn by turn instructions) must be sent to the local device.

App Library:
Currently, apps are loaded into the local device—either installed at time of purchase or added later. A significant market of post-sales installation of apps has developed. If efficient remote execution of apps is supported, then software rental becomes practical instead of software purchases. A fixed monthly fee would entitle the subscriber to access a large library of applications.

Mixed Models:
Mixed models of purchase and rental are practical. In this model, apps can be demo-ed remotely prior to purchase. If the user of the device finds the app to his/her liking, it can then be purchased.

Remote Enterprise Applications:
A good example of Remote Enterprise Applications is the integration of an enterprise environment. Let us follow a worker at a large enterprise as s/he proceeds through various computing environments during a typical day, starting at home at his/her computing setup, whether this is a traditional fixed (display, keyboard, mouse) device, a semi-fixed docked mobile computer, or a tablet. Even a tablet computer that is used for an extended period will benefit from some fixed infrastructure such as a docking station, stands and more traditional (keyboard, mouse) input methods.
Many applications can benefit from running within the enterprise's data centers which has the obvious benefits of scalability, security and maintainability. These applications are relatively easy to migrate to local devices, starting in the morning on a desktop device, then migrating to a mobile device (tablet or phone), continuing to the desktop device at the office, and back to the home device—indirectly or via several reincarnations.

Mobile Applications at an Enterprise:
Mobile applications run on a mobile device, typically a phone. They are possibly not the most comfortable for extended use. For extended stationary use, a tablet or a standard desktop computer is preferred. The most comfortable configuration is a tablet mounted in a stand that makes the tablet look somewhat like a standard computer monitor. A keyboard and mouse are used for user interaction, although the touch screen is still functional. Data connection can be via Ethernet. The phone would dock and connect to USB, audio in-out and power. The phone operates with a standard handset-headset via an onscreen dialer, the standard operating environment in use for the last 20 years.
Upon docking the phone, running applications migrate to the tablet. The optimal distance to the screen and the magnification effect, of lower dots per inch, will provide comfortable use of the phone's app without unneeded eyestrain. When the cellular phone rings, the handset is and answered, without fumbling for the mobile phone that might be in a pocket. Dialing a contact in the phone's addressbook via the corporate VoIP network, Skype or the cellular connection is performed. No cellular, Wi-Fi or Bluetooth data connection is used since these are too unreliable and insecure for enterprise use.

TABLE 1

| Line | LISTING 2 | LISTING 5 |
|---|---|---|
| 2 | Translate(0.0, 244.0); | Translate(0.0, 308.0) |
| 13 | DrawText(“Mandy”, 12, 0.0, | DrawText(“Paul”, 10, 0.0, 24.0, |
| | 24.0, 0xffffffff); | 0xffffffff); |
| 14 | DrawText(“Smith”, 10, 74.0, | DrawText(“Smith”, 10, 49.0, 24.0, |
| | 24.0, 0xffffffff); | 0xffffffff); |

TABLE 2

| Line | LISTING 2 | LISTING 6 |
|---|---|---|
| 2 | Translate(0.0, 244.0); | Translate(0.0, 202.0) |

TABLE 3

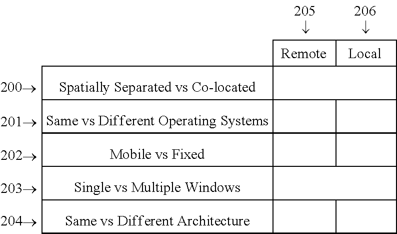

TABLE 4

| | Remote | Local |
|---|---|---|
| Spatially Separated vs Co-located | Spatially Separated | |
| Same vs Different Operating Systems | ANDROID ™ | ANDROID ™ |
| Mobile vs Fixed | Fixed | Mobile |
| Single vs Multiple Windows | Single Window | |
| Same vs Different Architecture | ARM | ARM |
| | Intel | |

TABLE 5

| | Remote | Local |
|---|---|---|
| Spatially Separated vs Co-located | Spatially Separated | |
| Same vs Different Operating Systems | Non- | ANDROID ™ |
| | ANDROID ™ | |
| Mobile vs Fixed | Fixed | Mobile |
| Single vs Multiple Windows | Single Window | |
| Same vs Different Architecture | ARM | ARM |
| | Intel | |

TABLE 6

| | Remote | Local |
|---|---|---|
| Spatially Separated vs Co-located | Spatially Separated/Co-located | |
| Same vs Different Operating Systems | ANDROID ™ | Non- |
| | | ANDROID ™ |
| Mobile vs Fixed | Fixed | Fixed |
| | | Mobile |
| Single vs Multiple Windows | Single Window | |
| Same vs Different Architecture | ARM | ARM |
| | Intel | Intel |

TABLE 7

| | Remote | Local |
|---|---|---|
| Spatially Separated vs Co-located | Co-located | |
| Same vs Different Operating Systems | ANDROID ™ | ANDROID ™ |
| Mobile vs Fixed | Fixed | Fixed |
| | Mobile | Mobile |
| Single vs Multiple Windows | Single Window | |
| Same vs Different Architecture | ARM | ARM/ |
| | Intel | Intel |

TABLE 8

| | Remote | Local |
|---|---|---|
| Spatially Separated vs Co-located | Co-located | |
| Same vs Different Operating Systems | ANDROID ™ | WINDOWS ® |
| | | Linux X11 |
| | | Apple OS/X |
| Mobile vs Fixed | Fixed | Fixed |
| | Mobile | Mobile |
| Single vs Multiple Windows | Single/Multiple | |
| Same vs Different Architecture | ARM | ARM |
| | Intel | Intel |

TABLE 9

| LISTING 3 | LISTING 22 |
|---|---|
| contact0( ) | func6( ) |
| contact1( ) | func3( ) |
| contact2( ) | func2( ) |
| contact3( ) | func1( ) |
| contact4( ) | func0( ) |
| contact5( ) | func5( ) |
| contact6( ) | func4( ) |

TABLE 10

| Rendering | |
|---|---|
| Command | Frequency |
| Restore | 2691 |
| Save | 2133 |
| DrawbitmapRect | 2109 |
| Translate | 2030 |
| ClipRect | 1828 |
| DrawRect | 1428 |
| DrawText | 602 |
| SaveLayer | 558 |
| Concat | 182 |
| DrawPaint | 60 |
| DrawColor | 60 |
| Bitmap | 16 |
| Drawbitmap | 3 |
| Canvas | 2 |

E = −Σpᵢlog₂
pᵢ = 2.983

LISTING 1

| | |
|---|---|
| 1 | Save(3); |
| 2 | Translate(0.0, 244.0); |
| 3 | ClipRect([0.0, 320.0, 0.0, 64.0], 0x1); |
| 4 | DrawRect([0.0, 320.0, 63.0, 64.0], 0xff333333); |
| 5 | Save(3); |
| 6 | Translate(62.0, 17.0); |
| 7 | ClipRect([0.0, 247.0, 0.0, 30.0], 0x1); |
| 8 | SaveLayer([0.0, 12.0, 0.0, 30.0], NULL, 4); |
| 9 | SaveLayer([235.0, 247.0, 0.0, 30.0], NULL, 4); |
| 10 | Save(3); |
| 11 | ClipRect([0.0, 247.0, 0.0, 30.0], 0x1); |
| 12 | Translate(0.0, 0.0); |
| 13 | DrawText(“Mandy ”, 12, 0.0, 24.0, 0xffffffff); |
| 14 | DrawText(“Smith”, 10, 74.0, 24.0, 0xffffffff); |
| 15 | Restore( ); |
| 16 | DrawRect([0.0, 12.0, 0.0, 30.0], 0x0); |
| 17 | DrawRect([235.0, 247.0, 0.0, 30.0], 0x0); |
| 18 | Restore( ); |
| 19 | Restore( ); |
| 20 | Restore( ); |
| 21 | Save(3); |
| 22 | Translate(4.0, 4.0); |
| 23 | ClipRect([0.0, 50.0, 0.0, 56.0], 0x1); |
| 24 | DrawbitmapRect(0x36acb0,[0 13 0 45], |

[0.0 13.0 0.0 45.0] ,0x0);

| | |
|---|---|
| 25 | DrawbitmapRect(0x36acb0,[13 14 0 45], |

[13.0 37.0 0.0 45.0] ,0x0);

| | |
|---|---|
| 26 | DrawbitmapRect(0x36acb0,[14 27 0 45], |

[37.0 50.0 0.0 45.0] ,0x0);

| | |
|---|---|
| 27 | DrawbitmapRect(0x36acb0,[0 13 45 46], |

[0.0 13.0 45.0 46.0] ,0x0);

| | |
|---|---|
| 28 | DrawRect([13.0, 37.0, 45.0, 46.0], 0x48ffffff); |
| 29 | DrawbitmapRect(0x36acb0,[14 27 45 46], |

[37.0 50.0 45.0 46.0] ,0x0);

| | |
|---|---|
| 30 | DrawbitmapRect(0x36acb0,[0 13 46 56], |

[0.0 13.0 46.0 56.0] ,0x0);

| | |
|---|---|
| 31 | DrawbitmapRect(0x36acb0,[13 14 46 56], |

[13.0 37.0 46.0 56.0] ,0x0);

| | |
|---|---|
| 32 | DrawbitmapRect(0x36acb0,[14 27 46 56], |

[37.0 50.0 46.0 56.0] ,0x0);

| | |
|---|---|
| 33 | Save(3); |
| 34 | Translate(4.0, 4.0); |
| 35 | Concat(0.875000, 0.0, 0.0, 0.0, |

0.875000, 0.0, 0.0, 0.0, 1.0);

| | |
|---|---|
| 36 | DrawbitmapRect(0x2e6900,[−1 −1 −1 −1], |

[0.0 48.0 0.0 48.0] ,0x0);

| | |
|---|---|
| 37 | Restore( ); |
| 38 | Restore( ); |
| 39 | Restore( ); |

LISTING 2

| | |
|---|---|
| 1 | { Save(3); |

| | |
|---|---|
| 2 | Translate(0.0, 244.0); |
| 3 | ClipRect([0.0, 320.0, 0.0, 64.0], 0x1); |
| 4 | DrawRect([0.0, 320.0, 63.0, 64.0], 0xff333333); |
| 5 | { Save(3); |

| | |
|---|---|
| 6 | Translate(62.0, 17.0); |
| 7 | ClipRect([0.0, 247.0, 0.0, 30.0], 0x1); |
| 8 | { SaveLayer([0.0, 12.0, 0.0, 30.0], NULL, 4); |

| | |
|---|---|
| 9 | { SaveLayer([235.0, 247.0, 0.0, 30.0], NULL, 4); |

| | |
|---|---|
| 10 | { Save(3); |

| | |
|---|---|
| 11 | ClipRect([0.0, 247.0, 0.0, 30.0], 0x1); |
| 12 | Translate(0.0, 0.0); |
| 13 | DrawText(“Mandy ”, 12, 0.0, 24.0, |
| | 0xffffffff); |
| 14 | DrawText(“Smith”, 10, 74.0, 24.0, |
| | 0xffffffff); |
| 15 | Restore( ); } |

| | |
|---|---|
| 16 | DrawRect([0.0, 12.0, 0.0, 30.0], 0x0); |
| 17 | DrawRect([235.0, 247.0, 0.0, 30.0], 0x0); |
| 18 | Restore( ); } |

| | |
|---|---|
| 19 | Restore( ); } |

| | |
|---|---|
| 20 | Restore( ); } |

| | |
|---|---|
| 21 | { Save(3); |

| | |
|---|---|
| 22 | Translate(4.0, 4.0); |
| 23 | ClipRect([0.0, 50.0, 0.0, 56.0], 0x1); |
| 24 | DrawbitmapRect(0x36acb0,[0 13 0 45], |

[0.0 13.0 0.0 45.0] ,0x0);

| | |
|---|---|
| 25 | DrawbitmapRect(0x36acb0,[13 14 0 45], |

[13.0 37.0 0.0 45.0] ,0x0);

| | |
|---|---|
| 26 | DrawbitmapRect(0x36acb0,[14 27 0 45], |

[37.0 50.0 0.0 45.0] ,0x0);

| | |
|---|---|
| 27 | DrawbitmapRect(0x36acb0,[0 13 45 46], |

[0.0 13.0 45.0 46.0] ,0x0);

| | |
|---|---|
| 28 | DrawRect([13.0, 37.0, 45.0, 46.0], 0x48ffffff); |
| 29 | DrawbitmapRect(0x36acb0,[14 27 45 46], |

[37.0 50.0 45.0 46.0] ,0x0);

| | |
|---|---|
| 30 | DrawbitmapRect(0x36acb0,[0 13 46 56], |

[0.0 13.0 46.0 56.0] ,0x0);

| | |
|---|---|
| 31 | DrawbitmapRect(0x36acb0,[13 14 46 56], |

[13.0 37.0 46.0 56.0] ,0x0);

| | |
|---|---|
| 32 | DrawbitmapRect(0x36acb0,[14 27 46 56], |

[37.0 50.0 46.0 56.0] ,0x0);

| | |
|---|---|
| 33 | { Save(3); |

| | |
|---|---|
| 34 | Translate(4.0, 4.0); |
| 35 | Concat(0.875000, 0.0, 0.0, 0.0, |

0.875000, 0.0, 0.0, 0.0, 1.0);

| | |
|---|---|
| 36 | DrawbitmapRect(0x2e6900,[−1 −1 −1 −1], |

[0.0 48.0 0.0 48.0] ,0x0);

| | |
|---|---|
| 37 | Restore( ); } |

| | |
|---|---|
| 38 | Restore( ); } |

| | |
|---|---|
| 39 | Restore( ); } |

LISTING 3

| | |
|---|---|
| 1 | void contact0( ){ |

| | |
|---|---|
| 2 | Save(3); |
| 3 | Translate(0.0, 244.0); |
| 4 | ClipRect([0.0, 320.0, 0.0, 64.0], 0x1); |
| 5 | DrawRect([0.0, 320.0, 63.0, 64.0], 0xff333333); |
| 6 | contact1( ); |
| 7 | contact5( ); |
| 8 | Restore( ); } |

| | |
|---|---|
| 9 | void contact1( ){ |

| | |
|---|---|
| 10 | Save(3); |
| 11 | Translate(62.0, 17.0); |
| 12 | ClipRect([0.0, 247.0, 0.0, 30.0], 0x1); |
| 13 | contact2( ); |
| 14 | Restore( ); } |

| | |
|---|---|
| 15 | void contact2( ){ |

| | |
|---|---|
| 16 | SaveLayer([0.0, 12.0, 0.0, 30.0], NULL, 4); |
| 17 | contact3( ); |
| 18 | Restore( ); } |

| | |
|---|---|
| 19 | void contact3( ){ |

| | |
|---|---|
| 20 | SaveLayer([235.0, 247.0, 0.0, 30.0], NULL, 4); |
| 21 | contact4( ); |
| 22 | DrawRect([0.0, 12.0, 0.0, 30.0], 0x0); |
| 23 | DrawRect([235.0, 247.0, 0.0, 30.0], 0x0); |
| 24 | Restore( ); } |

| | |
|---|---|
| 25 | void contact4( ){ |

| | |
|---|---|
| 26 | Save(3); |
| 27 | ClipRect([0.0, 247.0, 0.0, 30.0], 0x1); |
| 28 | Translate(0.0, 0.0); |
| 29 | DrawText(“Mandy ”, 12, 0.0, 24.0, 0xffffffff); |
| 30 | DrawText(“Smith”, 10, 74.0, 24.0, 0xffffffff); |
| 31 | Restore( ); } |

| | |
|---|---|
| 32 | void contact5( ){ |

| | |
|---|---|
| 33 | Save(3); |
| 34 | Translate(4.0, 4.0); |
| 35 | ClipRect([0.0, 50.0, 0.0, 56.0], 0x1); |
| 36 | DrawbitmapRect(0x36acb0,[0 13 0 45], |

[0.0 13.0 0.0 45.0] ,0x0);

| | |
|---|---|
| 37 | DrawbitmapRect(0x36acb0,[13 14 0 45], |

[13.0 37.0 0.0 45.0] ,0x0);

| | |
|---|---|
| 38 | DrawbitmapRect(0x36acb0,[14 27 0 45], |

[37.0 50.0 0.0 45.0] ,0x0);

| | |
|---|---|
| 39 | DrawbitmapRect(0x36acb0,[0 13 45 46], |

[0.0 13.0 45.0 46.0] ,0x0);

| | |
|---|---|
| 40 | DrawRect([13.0, 37.0, 45.0, 46.0], 0x48ffffff); |
| 41 | DrawbitmapRect(0x36acb0,[14 27 45 46], |

[37.0 50.0 45.0 46.0] ,0x0);

| | |
|---|---|
| 42 | DrawbitmapRect(0x36acb0,[0 13 46 56], |

[0.0 13.0 46.0 56.0] ,0x0);

| | |
|---|---|
| 43 | DrawbitmapRect(0x36acb0,[13 14 46 56], |

[13.0 37.0 46.0 56.0] ,0x0);

| | |
|---|---|
| 44 | DrawbitmapRect(0x36acb0,[14 27 46 56], |

[37.0 50.0 46.0 56.0] ,0x0);

| | |
|---|---|
| 45 | contact6( ); |
| 46 | Restore( ); } |

| | |
|---|---|
| 47 | void contact6( ){ |

| | |
|---|---|
| 48 | Save(3); |
| 49 | Translate(4.0, 4.0); |
| 50 | Concat(0.875000, 0.0, 0.0, 0.0, |

0.875000, 0.0, 0.0, 0.0, 1.0);

| | |
|---|---|
| 51 | DrawbitmapRect(0x2e6900,[−1 −1 −1 −1], |

[0.0 48.0 0.0 48.0] ,0x0);

| | |
|---|---|
| 52 | Restore( ); } |

LISTING 4

| | |
|---|---|
| 1 | void contact6(int i1, float t1, float t2, |

| | |
|---|---|
| 2 | float c1, float c2, float c3, float c4 |
| 3 | float c5, float c6, float c7, float c8, float c9, |
| 4 | bitmap b1, rect r1, rect r2, paint p1) |

| | |
|---|---|
| 5 | { |
| 6 | Save(i1); |
| 7 | Translate(t1, t2); |
| 8 | Concat(c1, c2, c3, c4, c5, c6, c7, c8, c9); |
| 9 | DrawbitmapRect(b1, r1, r2, p1); |
| 10 | Restore( ); |
| 11 | } |

LISTING 5

| | |
|---|---|
| 1 | { Save(3); |

| | |
|---|---|
| 2 | Translate(0.0, 308.0); |
| 3 | ClipRect([0.0, 320.0, 0.0, 64.0], 0x1); |
| 4 | DrawRect([0.0, 320.0, 63.0, 64.0], 0xff333333); |
| 5 | { Save(3); |

| | |
|---|---|
| 6 | Translate(62.0, 17.0); |
| 7 | ClipRect([0.0, 247.0, 0.0, 30.0], 0x1); |
| 8 | { SaveLayer([0.0, 12.0, 0.0, 30.0], NULL, 4); |

| | |
|---|---|
| 9 | { SaveLayer([235.0, 247.0, 0.0, 30.0], NULL, 4); |

| | |
|---|---|
| 10 | { Save(3); |

| | |
|---|---|
| 11 | ClipRect([0.0, 247.0, 0.0, 30.0], 0x1); |
| 12 | Translate(0.0, 0.0); |
| 13 | DrawText(“Paul ”, 10, 0.0, 24.0, |
| | 0xffffffff); |
| 14 | DrawText(“Smith”, 10, 49.0, 24.0, |
| | 0xffffffff); |
| 15 | Restore( ); } |

| | |
|---|---|
| 16 | DrawRect([0.0, 12.0, 0.0, 30.0], 0x0); |
| 17 | DrawRect([235.0, 247.0, 0.0, 30.0], 0x0); |
| 18 | Restore( ); } |

| | |
|---|---|
| 19 | Restore( ); } |

| | |
|---|---|
| 20 | Restore( ); } |

| | |
|---|---|
| 21 | { Save(3); |

| | |
|---|---|
| 22 | Translate(4.0, 4.0); |
| 23 | ClipRect([0.0, 50.0, 0.0, 56.0], 0x1); |
| 24 | DrawbitmapRect(0x36acb0,[0 13 0 45], |

[0.0 13.0 0.0 45.0] ,0x0);

| | |
|---|---|
| 25 | DrawbitmapRect(0x36acb0,[13 14 0 45], |

[13.0 37.0 0.0 45.0] ,0x0);

| | |
|---|---|
| 26 | DrawbitmapRect(0x36acb0,[14 27 0 45], |

[37.0 50.0 0.0 45.0] ,0x0);

| | |
|---|---|
| 27 | DrawbitmapRect(0x36acb0,[0 13 45 46], |

[0.0 13.0 45.0 46.0] ,0x0);

| | |
|---|---|
| 28 | DrawRect([13.0, 37.0, 45.0, 46.0], 0x48ffffff); |
| 29 | DrawbitmapRect(0x36acb0,[14 27 45 46], |

[37.0 50.0 45.0 46.0] ,0x0);

| | |
|---|---|
| 30 | DrawbitmapRect(0x36acb0,[0 13 46 56], |

[0.0 13.0 46.0 56.0] ,0x0);

| | |
|---|---|
| 31 | DrawbitmapRect(0x36acb0,[13 14 46 56], |

[13.0 37.0 46.0 56.0] ,0x0);

| | |
|---|---|
| 32 | DrawbitmapRect(0x36acb0,[14 27 46 56], |

[37.0 50.0 46.0 56.0] ,0x0);

| | |
|---|---|
| 33 | { Save(3); |

| | |
|---|---|
| 34 | Translate(4.0, 4.0); |
| 35 | Concat(0.875000, 0.0, 0.0, 0.0, |

0.875000, 0.0, 0.0, 0.0, 1.0);

| | |
|---|---|
| 36 | DrawbitmapRect(0x2e6900,[−1 −1 −1 −1], |

[0.0 48.0 0.0 48.0] ,0x0);

| | |
|---|---|
| 37 | Restore( ); } |

| | |
|---|---|
| 38 | Restore( ); } |

| | |
|---|---|
| 39 | Restore( ); } |

LISTING 6

| | |
|---|---|
| 1 | { Save(3); |

| | |
|---|---|
| 2 | Translate(0.0, 202.0); |
| 3 | ClipRect([0.0, 320.0, 0.0, 64.0], 0x1); |
| 4 | DrawRect([0.0, 320.0, 63.0, 64.0], 0xff333333); |
| 5 | { Save(3); |

| | |
|---|---|
| 6 | Translate(62.0, 17.0); |
| 7 | ClipRect([0.0, 247.0, 0.0, 30.0], 0x1); |
| 8 | { SaveLayer([0.0, 12.0, 0.0, 30.0], NULL, 4); |

| | |
|---|---|
| 9 | { SaveLayer([235.0, 247.0, 0.0, 30.0], NULL, 4); |

| | |
|---|---|
| 10 | { Save(3); |

| | |
|---|---|
| 11 | ClipRect([0.0, 247.0, 0.0, 30.0], 0x1); |
| 12 | Translate(0.0, 0.0); |
| 13 | DrawText(“Mandy ”, 12, 0.0, 24.0, |
| | 0xffffffff); |
| 14 | DrawText(“Smith”, 10, 74.0, 24.0, |
| | 0xffffffff); |
| 15 | Restore( ); } |

| | |
|---|---|
| 16 | DrawRect([0.0, 12.0, 0.0, 30.0], 0x0); |
| 17 | DrawRect([235.0, 247.0, 0.0, 30.0], 0x0); |
| 18 | Restore( ); } |

| | |
|---|---|
| 19 | Restore( ); } |

| | |
|---|---|
| 20 | Restore( ); } |

| | |
|---|---|
| 21 | { Save(3); |

| | |
|---|---|
| 22 | Translate(4.0, 4.0); |
| 23 | ClipRect([0.0, 50.0, 0.0, 56.0], 0x1); |
| 24 | DrawbitmapRect(0x36acb0,[0 13 0 45], |

[0.0 13.0 0.0 45.0] ,0x0);

| | |
|---|---|
| 25 | DrawbitmapRect(0x36acb0,[13 14 0 45], |

[13.0 37.0 0.0 45.0] ,0x0);

| | |
|---|---|
| 26 | DrawbitmapRect(0x36acb0,[14 27 0 45], |

[37.0 50.0 0.0 45.0] ,0x0);

| | |
|---|---|
| 27 | DrawbitmapRect(0x36acb0,[0 13 45 46], |

[0.0 13.0 45.0 46.0] ,0x0);

| | |
|---|---|
| 28 | DrawRect([13.0, 37.0, 45.0, 46.0], 0x48ffffff); |
| 29 | DrawbitmapRect(0x36acb0,[14 27 45 46], |

[37.0 50.0 45.0 46.0] ,0x0);

| | |
|---|---|
| 30 | DrawbitmapRect(0x36acb0,[0 13 46 56], |

[0.0 13.0 46.0 56.0] ,0x0);

| | |
|---|---|
| 31 | DrawbitmapRect(0x36acb0,[13 14 46 56], |

[13.0 37.0 46.0 56.0] ,0x0);

| | |
|---|---|
| 32 | DrawbitmapRect(0x36acb0,[14 27 46 56], |

[37.0 50.0 46.0 56.0] ,0x0);

| | |
|---|---|
| 33 | { Save(3); |

| | |
|---|---|
| 34 | Translate(4.0, 4.0); |
| 35 | Concat(0.875000, 0.0, 0.0, 0.0, |

0.875000, 0.0, 0.0, 0.0, 1.0);

| | |
|---|---|
| 36 | DrawbitmapRect(0x2e6900,[−1 −1 −1 −1], |

[0.0 48.0 0.0 48.0] ,0x0);

| | |
|---|---|
| 37 | Restore( ); } |

| | |
|---|---|
| 38 | Restore( ); } |

| | |
|---|---|
| 39 | Restore( ); } |

LISTING 7

| | |
|---|---|
| 1 | #include <stdio.h> |
| 2 | #include <stdlib.h> |
| 3 | #include <string.h> |
| 4 | #include <openssl/md5.h> |
| 5 | |
| 6 | // Control sequence structure, linked list. |
| 7 | struct control_seq { |

| | |
|---|---|
| 8 | char *func_name; |
| 9 | int func_tbl; |
| 10 | struct control_seq *cs; // link to next line |

| | |
|---|---|
| 11 | }; |
| 12 | |
| 13 | // Data sequence structure, double linked list. |
| 14 | struct data_seq { |

| | |
|---|---|
| 15 | char *data; |
| 16 | struct control_seq *ef; |
| 17 | struct data_seq *ed; |
| 18 | struct data_seq *ds; // link to next line |
| 19 | struct data_seq *next; // link within function table |

| | |
|---|---|
| 20 | }; |
| 21 | |
| 22 | #define NFUNCS 1024 |
| 23 | // Function table for unique control sequences (functions) |
| 24 | struct func_table { |

| | |
|---|---|
| 25 | unsigned char *md5; |
| 26 | struct control_seq *pcs; |
| 27 | struct data_seq *pds; |
| 28 | int valid; |
| 29 | int flines; |

| | |
|---|---|
| 30 | } funcs[NFUNCS]; |
| 31 | |
| 32 | // Number of functions in table |
| 33 | int ntable; |
| 34 | // Number if functions seen |
| 35 | int nfuncs; |

LISTING 8

36
37 // Send a complete control sequence
38 void send_control_seq(control_seq *cs)
39 {
40 }
41
42 // Send a complete data segment
43 void send_whole_data_seq(int fn, data_seq *dseg)
44 {
45 }
46
47 // Send a diff of a data sequence in reference to ’dn’
48 void send_diff_data_seq(int fn, data_seq *dseg, int dn)
49 {
50 }
51
52 // Return the next character.
53 // Skip over don't care character
54 int scanchar(void)
55 {
56 int c;
57 while((c= fgetc(stdin)) != EOF) {
58 if(c == ’ ’ || c == ’\t’ || c == ’{’
59 || c == ’}’ || c == ’/’
60 || c == ’;’ || c == ’\n’)
61 continue;
62 break;
63 }
64 return(c);
65 }
66

LISTING 9

```
  67 // Get the next function and data parameters
  68 char *getfunc(char **data)
  69 {
  70  char d[500];
  71  char *dd;
  72  char fn[30];
  73  char *pfn;
  74  int c;
  75  char *funct;
  76  static int on=1;
  77
  78  pfn= fn;
  79  dd= d;
  80  while((c= scanchar( )) != EOF) {
  81  if(c == ’(’) {
  82  on= 0;
  83  *pfn= 0;
  84  funct= (char *) malloc(strlen(fn) +1);
  85  strcpy(funct, fn);
  86  }
  87  if(on)
  88  *pfn++ = c;
  89  else
  90  *dd++ = c;
  91  if(c == ’)’) {
  92  pfn= fn;
  93  on= 1;
  94  *dd= 0;
  95  dd= (char *) malloc(strlen(d) +1);
  96  strcpy(dd, d);
  97  *data= dd;
  98  return(funct);
  99  }
100  }
101  return(NULL);
102 }
```

LISTING 10

```
    103
104 // Return the MD5 checksum of the control sequence
105 unsigned char *calc_hash(control_seq *pcs)
106 {
107  int n= 0;
108  unsigned char *md;
109  MD5_CTX md5;
110
111  md= (unsigned char *) malloc(16);
112  MD5_Init(&md5);
113  while(pcs) {
114  if(pcs->func_name) {
115  MD5_Update(&md5, pcs->func_name,
          strlen(pcs->func_name));
116  } else {
117  MD5_Update(&md5, (void *) &n, sizeof n);
118  }
119  pcs= pcs->cs;
120  n++;
121  }
122  MD5_Final(md, &md5);
123  return(md);
124 }
```

LISTING 11

125
126 // Return the number of lines in the control sequence
127 int cmd_lines(control_seq *pcs)
128 {
129 int lines= 0;
130 while(pcs) {
131 if(pcs->func_name)
132 lines++;
133 pcs= pcs->cs;
134 }
135 return(lines);
136 }

LISTING 12

137
138 // Insert control sequence into the function table
139 int store_func(control_seq *pcs)
140 {
141 unsigned char *md;
142 func_table *f= funcs;
143 md= calc_hash(pcs);
144 int i;
145 for(i=0; i < NFUNCS; i++) {
146 if(funcs[i].valid == 0)
147 break;
148 if(memcmp(funcs[i].md5, md, 16) == 0) // match found
149 return(i);
150 }
151 // Add new entry into table
152 funcs[i].md5= md;
153 funcs[i].pcs= pcs;
154 funcs[i].valid= 1;
155 funcs[i].flines= cmd_lines(pcs);
156 ntable++;
157 return(i);
158 }

LISTING 13

159
160 // Print one control sequence
161 void print_cs2(control_seq *pcs)
162 {
163 unsigned char *md;
164 int i;
165
166 while(pcs) {
167 if(pcs->func_name)
168 printf(“%s\n”, pcs->func_name);
169 else {
170 printf(“->function\n”);
171 }
172 pcs= pcs->cs;
173 }
174 }

LISTING 14

175
176 // Add cumulative statistics
177 int cum_lines, cum_clines, cum_dlines;
178
179 void add_stats(int lines, int clines, int dlines)
180 {
181 cum_lines+= lines;
182 cum_clines+= clines;
183 cum_dlines+= dlines;
184 }
185
186 // Print cumulative statistics
187 void print_stats( )
188 {
189 static int frame_num= 1;
190 printf(“%d: Data %d, %d, %d, funcs %d, %d\n”,
191 frame_num++,cum_lines,cum_clines,cum_dlines,nfuncs,
ntable);
192 }

LISTING 15

193
194 // Find the closest previously seen data sequence if possible
195 int diff_func(int func_num, data_seq *dseg, data_seq *ds)
196 {
197 int diffs= 99999;
198 int data_num= 0;
199 int min_data_num= 0;
200 while(ds) {
201 data_seq *ds2= ds;
202 data_seq *dseg2= dseg;
203 int d= 0;
204 while(dseg2) {
205 if(ds2->data && dseg2->data)
206 if(strcmp(ds2->data, dseg2->data))
207 d++;
208 ds2= ds2->ds;
209 dseg2= dseg2->ds;
210 }
211 if(d<diffs) {
212 diffs= d;
213 min_data_num= data_num;
214 }
215 ds= ds->next;
216 data_num++;
217 }
218 if(diffs == 99999) {
219 send_whole_data_seq(func_num, dseg);
220 add_stats(funcs[func_num].flines,
221 funcs[func_num].flines, 0);
222 } else {
223 send_diff_data_seq(func_num, dseg, min_data_num);
224 add_stats(funcs[func_num].flines, 0, diffs);
225 }
226 return(diffs);
227 }

LISTING 16

228
229 // Print recursively control and data sequences
230 void print_cs(control_seq *pcs, data_seq *pds, int indent)
231 {
232 char ind[100];
233 int i;
234
235 memset(ind, ’ ’, 2*indent);
236 ind[2*indent]= 0;
237 printf(“%s{\n”, ind);
238 while(pcs && pds) {
239 if(pcs->func_name)
240 printf(“%s%s”, ind, pcs->func_name);
241 if(pds->data)
242 printf(“%s;”, pds->data);
243 if(pds->ef)
244 print_cs(pds->ef, pds->ed, indent+1);
245 printf(“\n”);
246 pcs= pcs->cs;
247 pds= pds->ds;
248 }
249 printf(“%s}”, ind);
250 }

LISTING 17

251
252 // Recursively parse the rendering trace.
253 // This can parse full frames.
254 // Prime the pump with the first line (control, data)
255 control_seq *get_cs(char *first_func, char *first_data,
256 data_seq **ppds)
257 {
258 char *f;
259 control_seq *cseq;
260 control_seq *cont_seq;
261 control_seq *last_cont_seq =0;
262 data_seq *dseq;
263 data_seq *da_seq;
264 data_seq *last_data_seq =0;
265 char *data;
266
267 nfuncs++;
268 cseq= (control_seq *) malloc(sizeof (control_seq));
269 cseq->func_name= first_func;
270 cseq->cs= 0;
271 last_cont_seq= cseq;
272 dseq= (data_seq *) malloc(sizeof (data_seq));
273 dseq->data= first_data;
274 dseq->ef= 0;
275 dseq->ed= 0;
276 dseq->ds= 0;
277 last_data_seq= dseq;
278
279 while(f= getfunc(&data)) {
280 if(strncmp(f, “Save”, 4) == 0) {
281 control_seq *pcs;
282 data_seq *pds;
283 pcs= get_cs(f, data, &pds);
284 cont_seq= (control_seq *) malloc(sizeof (control_seq));
285 cont_seq->func_name= 0;
286 cont_seq->cs= 0;
287 da_seq= (data_seq *) malloc(sizeof (data_seq));
288 da_seq->data= 0;
289 da_seq->ef= pcs;
290 da_seq->ed= pds;
291 da_seq->ds= 0;
292 } else {
293 cont_seq= (control_seq *) malloc(sizeof (control_seq));
294 cont_seq->func_name= f;
295 cont_seq->cs= 0;
296 da_seq= (data_seq *) malloc(sizeof (data_seq));
297 da_seq->data= data;
298 da_seq->ef= 0;
299 da_seq->ed= 0;
300 da_seq->ds= 0;
301 }
302 last_cont_seq->cs= cont_seq;
303 last_cont_seq= cont_seq;
304 last_data_seq->ds= da_seq;
305 last_data_seq= da_seq;
306
307 if(strcmp(f, “Restore”) == 0) {
308 int i;
309 data_seq *ds;
310 int diffs;
311
312 i= store_func(cseq);
313 send_control_seq(cseq); // Transmit control sequence
314 cseq->func_tbl= i;
315 ds= funcs[i].pds;
316 diffs= diff_func(i, dseq, ds);
317 dseq->next= ds;
318 funcs[i].pds= dseq;
319 *ppds= dseq;
320 return(cseq);
321 }
322 }
323 return(0);
324 }

LISTING 18

325
326 // Return the index of a control sequence in the function table.
327 int func_num(control_seq *pcs)
328 {
329 int n;
330 unsigned char *md5;
331
332 md5= calc_hash(pcs);
333 for(n=0; n < NFUNCS; n++) {
334 if(memcmp(md5, funcs[n].md5, 16) == 0) {
335 free(md5);
336 return(n);
337 }
338 }
339 free(md5);
340 return(99);
341 }

LISTING 19

342
343 // Print the function table
344 void print_func_tbl( )
345 {
346 int i, j;
347
348 for(i=0; i < NFUNCS; i++) {
349 data_seq *pds= funcs[i].pds;
350 if(funcs[i].valid == 0)
351 break;
352 j= 0;
353 while(pds) {
354 j++;
355 pds= pds->next;
356 }
357 printf(“func%d(%d,%d){\n”, i, cmd_lines(funcs[i].pcs), j);
358 print_cs2(funcs[i].pcs);
359 printf(“}\n”);
360 }
361 }

LISTING 20

362
363 int main(int argc, char *argv[ ])
364 {
365 control_seq *cs;
366 data_seq *ds;
367 char *func;
368 char *data;
369
370 // Each get_cs( ) will return one frame
371 while(func= getfunc(&data)) {
372 cs= get_cs(func, data, &ds);
373 print_stats( ); // Print cumulative statistics
374 }
375
376 print_func_tbl( );
377 return(0);
378 }

LISTING 21

| | |
|---|---|
| Data | Funcs |

| Frame | Total | Sent | Diff | Total | Sent |
|---|---|---|---|---|---|
| 1 | 190, | 84, | 31, | 39, | 14 |
| 2 | 650, | 173, | 73, | 126, | 25 |
| 3 | 1106, | 196, | 74, | 213, | 27 |
| 4 | 1562, | 196, | 75, | 300, | 27 |
| 5 | 1663, | 216, | 80, | 320, | 31 |
| 6 | 1764, | 216, | 80, | 340, | 31 |
| 7 | 1856, | 222, | 80, | 360, | 32 |
| 8 | 2172, | 238, | 90, | 418, | 33 |
| 9 | 2270, | 258, | 90, | 438, | 36 |
| 10 | 2575, | 258, | 90, | 496, | 36 |
| 11 | 2889, | 258, | 90, | 554, | 36 |
| 12 | 3203, | 258, | 90, | 612, | 36 |
| 13 | 3517, | 258, | 90, | 670, | 36 |
| 14 | 3683, | 269, | 98, | 710, | 38 |
| 15 | 3849, | 269, | 98, | 750, | 38 |
| 16 | 4163, | 269, | 99, | 808, | 38 |
| 17 | 4264, | 269, | 100, | 828, | 38 |
| 18 | 4365, | 269, | 101, | 848, | 38 |
| 19 | 4466, | 269, | 102, | 868, | 38 |
| 20 | 4567, | 269, | 102, | 888, | 38 |
| 21 | 4659, | 269, | 102, | 908, | 38 |
| 22 | 4973, | 284, | 111, | 966, | 39 |
| 23 | 5058, | 288, | 115, | 984, | 40 |
| 24 | 5370, | 296, | 134, | 1041, | 41 |
| 25 | 5693, | 318, | 143, | 1099, | 43 |
| 26 | 6016, | 318, | 143, | 1157, | 43 |
| 27 | 6339, | 318, | 143, | 1215, | 43 |
| 28 | 6512, | 325, | 149, | 1256, | 44 |
| 29 | 6685, | 325, | 149, | 1297, | 44 |
| 30 | 6858, | 325, | 149, | 1338, | 44 |
| 31 | 7181, | 325, | 150, | 1396, | 44 |
| 32 | 7369, | 325, | 155, | 1438, | 44 |
| 33 | 7461, | 325, | 162, | 1456, | 44 |
| 34 | 7553, | 325, | 163, | 1474, | 44 |
| 35 | 7645, | 325, | 163, | 1492, | 44 |
| 36 | 7728, | 331, | 163, | 1510, | 45 |
| 37 | 8051, | 346, | 163, | 1568, | 46 |
| 38 | 8136, | 346, | 166, | 1586, | 46 |
| 39 | 8474, | 346, | 184, | 1648, | 46 |
| 40 | 8788, | 346, | 184, | 1706, | 46 |
| 41 | 9102, | 346, | 184, | 1764, | 46 |
| 42 | 9416, | 346, | 184, | 1822, | 46 |
| 43 | 9730, | 346, | 184, | 1880, | 46 |
| 44 | 9896, | 346, | 184, | 1920, | 46 |
| 45 | 10210, | 346, | 185, | 1978, | 46 |
| 46 | 10416, | 354, | 186, | 2024, | 47 |
| 47 | 10622, | 354, | 186, | 2070, | 47 |
| 48 | 10819, | 354, | 186, | 2116, | 47 |
| 49 | 11124, | 354, | 186, | 2174, | 47 |
| 50 | 11462, | 354, | 202, | 2236, | 47 |
| 51 | 11785, | 354, | 202, | 2294, | 47 |
| 52 | 12108, | 354, | 202, | 2352, | 47 |
| 53 | 12431, | 354, | 203, | 2410, | 47 |
| 54 | 12754, | 354, | 203, | 2468, | 47 |
| 55 | 12837, | 354, | 203, | 2486, | 47 |
| 56 | 13010, | 354, | 203, | 2527, | 47 |
| 57 | 13183, | 354, | 203, | 2568, | 47 |
| 58 | 13356, | 354, | 203, | 2609, | 47 |
| 59 | 13529, | 354, | 203, | 2650, | 47 |
| 60 | 13702, | 354, | 203, | 2691, | 47 |

LISTING 22

| | |
|---|---|
| Data | Funcs |

| Frame | Total | Sent | Diff | Total | Sent |
|---|---|---|---|---|---|
| 1 | 39, | 39, | 0, | 7, | 7 |
| 2 | 78, | 39, | 3, | 14, | 7 |

| | |
|---|---|
| 3 | func0(6,2){ |
| 4 | Save |
| 5 | ClipRect |
| 6 | Translate |
| 7 | DrawText |
| 8 | DrawText |
| 9 | Restore |
| 10 | } |
| 11 | func1(4,2){ |
| 12 | SaveLayer |
| 13 | ->function |
| 14 | DrawRect |
| 15 | DrawRect |
| 16 | Restore |
| 17 | } |
| 18 | func2(2,2){ |
| 19 | SaveLayer |
| 20 | ->function |
| 21 | Restore |
| 22 | } |
| 23 | func3(4,2){ |
| 24 | Save |
| 25 | Translate |
| 26 | ClipRect |
| 27 | ->function |
| 28 | Restore |
| 29 | } |
| 30 | func4(5,2){ |
| 31 | Save |
| 32 | Translate |
| 33 | Concat |
| 34 | DrawbitmapRect |
| 35 | Restore |
| 36 | } |
| 37 | func5(13,2){ |
| 38 | Save |
| 39 | Translate |
| 40 | ClipRect |
| 41 | DrawbitmapRect |
| 42 | DrawbitmapRect |
| 43 | DrawbitmapRect |
| 44 | DrawbitmapRect |
| 45 | DrawRect |
| 46 | DrawbitmapRect |
| 47 | DrawbitmapRect |
| 48 | DrawbitmapRect |
| 49 | DrawbitmapRect |
| 50 | ->function |
| 51 | Restore |
| 52 | } |
| 53 | func6(5,2){ |
| 54 | Save |
| 55 | Translate |
| 56 | ClipRect |
| 57 | DrawRect |
| 58 | ->function |
| 59 | ->function |
| 60 | Restore |
| 61 | } |

What is claimed is:

1. A system for remote graphics using a distributed graphics stack, comprising:
a first computing device, having a first processor and running a first operating system, comprising:
a user application that is executed by the first processor;
a graphics toolkit coupled with said user application for performing graphics operations required by said user application;
a first graphics renderer coupled with said graphics toolkit for rendering a graphical user interface for the user application as requested by said graphics toolkit;
a first extension stub to said first graphical renderer coupled with said first graphics renderer for assembling rendering procedure calls into a data stream; and
a transmitter coupled with said first extension stub for transmitting the data stream generated by said first extension stub to a second computing device;
a second computing device, having a second processor and running a second operating system, comprising:
a display for displaying composed graphics;
a pixel buffer for rendering graphics;
a receiver for receiving the data stream from said first computing device;
a second extension stub coupled with said receiver for disassembling the rendering procedure calls from the received data stream;
a second graphics renderer coupled with said second extension stub for rendering the procedure calls disassembled by the second extension stub on said pixel buffer; and
a surface composer coupled with said second graphics renderer for composing graphics from said pixel buffer on said display.

2. The system of claim 1 wherein the first processor has a different architecture than the second processor.

3. The system of claim 1 wherein the first and second processor have the same architecture.

4. The system of claim 1 wherein the first processor has an architecture from the group consisting of an Intel architecture and an ARM architecture.

5. The system of claim 1 wherein the second processor has an architecture from the group consisting of an Intel architecture and an ARM architecture.

6. The system of claim 1 wherein the first operating system is of a different type than the second operating system.

7. The system of claim 1 wherein the first and second operating systems are of the same type.

8. The system of claim 1 wherein the first operating system is a multiple windows system, wherein a user application maps to its own window.

9. The system of claim 1 wherein the first operating system is a single window system, which provides a view of one application at a time.

10. The system of claim 1 wherein the second operating system is a multiple windows system, wherein a user application maps to its own window.

11. The system of claim 1 wherein the second operating system is a single window system, which provides a view of one application at a time.

12. The system of claim 1 wherein said first computing device graphics renderer comprises a SKIA renderer.

13. The system of claim 1 wherein said second computing device graphics renderer comprises a SKIA renderer.

14. The system of claim 1 wherein the first computing device is a cloud server.

15. The system of claim 1 wherein the second computing device is a desktop client.

16. A method for remote graphics using a distributed graphics stack, comprising:
assembling, by a first computing device, a plurality of rendering procedure calls into a data stream;
transmitting the data stream from the first computing device to a second computing device;
disassembling, by the second computing device, the data stream into a plurality of rendering procedure calls;
rendering the rendering procedure calls by the second computing device, to generate rendered graphics; and
composing the rendered graphics on a display of the second computing device.

17. The method of claim 16 wherein said assembling comprises compressing the plurality of rendering procedure calls, and wherein said disassembling comprises decompressing the plurality of rendering procedure calls.

18. The method of claim 17 wherein said compressing comprises tracking, by the first computing device, a local storage of objects on the second computing device, the objects having been transmitted by the first computing device to the second computing device in the data stream.

19. The method of claim 17 wherein the plurality of rendering procedure calls comprise multiple frames, each frame for composing on the display of the second computing device, and wherein said compressing applies inter-frame compression based on differences between frames.
